(19) United States
(12) Patent Application Publication
(10) Pub. No.: US 2013/0319646 A1
(43) Pub. Date: Dec. 5, 2013

(54) HEAT TRANSFER

(71) Applicants: Itai Einav, Willoughby (AU); Pierre Rognon, Glebe (AU)

(72) Inventors: Itai Einav, Willoughby (AU); Pierre Rognon, Glebe (AU)

(73) Assignee: THE UNIVERSITY OF SYDNEY, Sydney (AU)

(21) Appl. No.: 13/882,160

(22) PCT Filed: Oct. 28, 2011
(86) PCT No.: PCT/AU11/01394

§ 371 Date: Aug. 21, 2013

(30) Foreign Application Priority Data
Oct. 28, 2010 (AU) 2010904807

(51) Int. Cl. B23P 15/26; F28F 7/00

(52) U.S. Cl. CPC B23P 15/26; F28F 7/00
USPC 165/185; 29/890.03

(57) ABSTRACT

The invention relates to a method for transferring heat between a first material having a first temperature and a second material having a second temperature, wherein said first temperature is greater than said second temperature, said method comprising providing one or more rotatable elements, disposing said one or more rotatable elements such that a heat transfer portion thereof is thermally contactable with both said first material and said second material on rotation of said one or more rotatable elements, and rotating said one or more rotatable elements, whereby heat is transferred from said first material to said heat transfer portion and from said heat transfer portion to said second material.

### TECHNICAL FIELD

The present invention relates to methods and devices for transferring heat.

### RELATED APPLICATION

This application claims priority from Australian Provisional Patent Application No. 2010904807, which is incorporated herein in its entirety by cross-reference.

### BACKGROUND OF THE INVENTION

Any discussion of the background art throughout the specification should in no way be considered as an admission that such background art is prior art, nor that such background art is widely known or forms part of the common general knowledge in the field.

Heat may be transferred from one material to another by means of radiation, conduction and convection. Methods and devices for heat transfer may be utilised in a range of applications for increasing or decreasing the temperature of a material. Applications include mechanical engineering, electrical engineering, aeronautical engineering, civil engineering, chemical engineering, energy production, mining engineering and mineral processing, pharmaceutics, material engineering and agriculture.

In some applications heat transfer is utilised to decrease the temperature of a heat source. For example, heat transfer devices are employed to cool the central processing units of computers. In other applications it is advantageous to heat materials, to insulate materials and/or to enhance heat storage.

Existing methods and devices for heat transfer suffer from inefficiencies that limit the rate of heat transfer. Furthermore, existing methods and devices do not allow the efficiency of heat transfer to be adjusted.

Accordingly, there is a need to provide methods and devices that improve the efficiency and/or adjustability of heat transfer between materials.

### SUMMARY OF INVENTION

According to a first aspect of the present invention there is provided a method for transferring heat between a first material having a first temperature and a second material having a second temperature, wherein said first temperature is greater than said second temperature, said method comprising:
(a) providing one or more rotatable elements;
(b) disposing said one or more rotatable elements such that a heat transfer portion thereof is thermally contactable with both said first material and said second material on rotation of said one or more rotatable elements,
(c) rotating said one or more rotatable elements,
   whereby heat is transferred from said first material to said heat transfer portion and from said heat transfer portion to said second material.

The following options may be used in combination with the above aspect, either individually or in any suitable combination.

At least one, optionally both, of the first material and the second material may be a fluid. In operation of the method the fluid may be passed across the surface of and/or through the one or more rotatable elements. The fluid may be passed across the surface of and/or through the one or more rotatable elements by pumping the fluid. The passing of the fluid across or through the one or more rotatable elements may, in some embodiments, drive rotation of the one or more rotatable elements.

At least one, optionally both, of said first material and said second material may comprise a solid surface. In this case, in operation of the method, rotation of the rotatable elements may comprise rolling across the solid surface. There may be substantially no slippage between the one or more rotatable elements and the surface. A pressure may be applied urging the one or more rotatable elements onto the solid surface. At least a portion of the surface of the one or more rotatable elements may be elastic so that the pressure causes the one or more rotatable elements to partially flatten against the solid surface. At least a portion of the solid surface may be elastic. These options may increase the contact area between the solid surface(s) and the rotatable element(s), which may improve the heat transfer.

In an embodiment, the first material is a fluid and the second material comprises a solid surface or the first material comprises a solid surface and the second material is a fluid. The method may further comprise providing one or more additional rotatable elements that are not in thermal contact with said solid surface, said method further comprising the steps of:
(d) disposing said one or more additional rotatable elements such that a heat transfer portion thereof is thermally contactable with both said one or more rotatable elements in contact with the solid surface and said fluid; and
(e) rotating said one or more additional rotatable elements.

Rotation of the one or more rotatable elements in contact with the solid surface may cause rotation of the one or more additional rotatable elements. Rotation of the one or more additional rotatable elements may cause rotation of the one or more rotatable elements.

There may be a plurality of rotatable elements that are thermally contactable with both the first material and second material. Each rolling element may contact one or more adjacent rotatable elements. Each rolling element may contact a plurality of adjacent rotatable elements. There may be substantially no slippage between adjacent rotatable elements so that the rotation of the plurality of rotatable elements is co-ordinated.

According to a second aspect of the present invention there is provided a method for transferring heat between a solid surface and a material having a different temperature to said solid surface, wherein said method comprises providing one or more rotatable elements and further comprising the simultaneous steps of:
(a) maintaining thermal contact between said one or more rotatable elements and said solid surface;
(b) maintaining thermal contact between said one or more rotatable elements and said material; and
(c) rotating said one or more rotatable elements,
   whereby either (i) heat is transferred from the solid surface to the one or more rotatable elements and from the one or more rotatable elements to the material; or (ii) heat is transferred from the material to the one or more rotatable elements and from the one or more rotatable elements to the solid surface.

The following options may be used in combination with the above aspect, either individually or in any suitable combination.

The rotatable element(s) may be rolling elements. They may be rollers. They may be rotatable discs. The material may be a fluid, for example a liquid or a gas.

In operation of the method the material may be passed across the surface of and/or through the one or more rotatable elements. The material may be passed across the surface of and/or through said one or more rotatable elements by pumping the material. The passing of the material across or through the one or more rotatable elements may drive rotation of the one or more rotatable elements.

In operation of the method, rotation of the rotatable elements may comprise rolling across the solid surface. There may be substantially no slippage between the one or more rotatable elements and the surface.

A pressure may be applied urging the one or more rotatable elements onto the solid surface. At least a portion of the surface of the one or more rotatable elements may be elastic so that the pressure causes the one or more rotatable elements to partially flatten against the solid surface. At least a portion of the solid surface may be elastic.

There may be a plurality of rotatable elements in contact with the surface. Each rolling element may contact one or more adjacent rotatable elements. Each rolling element may contact a plurality of adjacent rotatable elements. There may be substantially no slippage between adjacent rotatable elements so that the rotation of the plurality of rotatable elements is co-ordinated.

The method may further comprise providing one or more additional rotatable elements that are not in physical contact with said solid surface, the method comprising the steps, simultaneous with steps (a) to (c), of:
(d) maintaining thermal contact between the one or more additional rotatable elements and the material; and
(e) maintaining thermal contact between the one or more additional rotatable elements and at least one of the one or more rotatable elements; and
(f) rotating the one or more additional rotatable elements.

Heat may additionally be transferred from the one or more rotatable elements to the one or more additional rotatable elements and from the one or more additional rotatable elements to the material. Heat may additionally be transferred from the material to the one or more additional rotatable elements and from the one or more additional rotatable elements to the one or more rotatable elements. Rotation of the one or more rotatable elements may cause rotation of the one or more additional rotatable elements. Rotation of the one or more additional rotatable elements may cause rotation of the one or more rotatable elements.

In an embodiment there is provided a method for transferring heat between a solid surface and a fluid (e.g. a gas or liquid) having a different temperature to the solid surface, wherein said method comprises providing one or more rotatable elements and further comprising the simultaneous steps of:
(a) maintaining thermal contact between the one or more rotatable elements and the solid surface;
(b) maintaining thermal contact between the one or more rotatable elements and the fluid by passing the fluid across the surface of the one or more rotatable elements; and
(c) rotating the one or more rotatable elements,
   whereby either (i) heat is transferred from the solid surface to the one or more rotatable elements and from the one or more rotatable elements to the liquid; or (ii) heat is transferred from the liquid to the one or more rotatable elements and from the one or more rotatable elements to the solid surface.

In another embodiment there is provided a method for transferring heat between a solid surface and a fluid (e.g. a gas or liquid) having a different temperature to the solid surface, wherein said method comprises providing a plurality of rotatable elements and further comprising the simultaneous steps of:
(a) maintaining thermal contact between the plurality of rotatable elements and the solid surface;
(b) maintaining thermal contact between the plurality of rotatable elements and the fluid by passing the liquid across the surface of the plurality of rotatable elements; and
(c) rotating the plurality of rotatable elements,
   whereby either (i) heat is transferred from the solid surface to the one or more rotatable elements and from the one or more rotatable elements to the fluid; or (ii) heat is transferred from the fluid to the one or more rotatable elements and from the one or more rotatable elements to the solid surface.

In another embodiment there is provided a method for transferring heat between a solid surface and a fluid (e.g. a gas or liquid) having a different temperature to the solid surface, wherein said method comprises providing one or more rotatable elements and further comprising the simultaneous steps of:
(a) maintaining thermal contact between the one or more rotatable elements and the solid surface;
(b) maintaining thermal contact between the one or more rotatable elements and the fluid by passing the liquid across the surface of the one or more rotatable elements; and
(c) rotating the one or more rotatable elements, wherein rotation of each of the rotatable elements comprises rolling across the solid surface,
   whereby either (i) heat is transferred from the solid surface to the one or more rotatable elements and from the one or more rotatable elements to the fluid; or (ii) heat is transferred from the fluid to the one or more rotatable elements and from the one or more rotatable elements to the solid surface.

In another embodiment there is provided a method for transferring heat between a solid surface and a fluid (e.g. a gas or liquid) having a different temperature to the solid surface, wherein said method comprises providing one or more rotatable elements and further comprising the simultaneous steps of:
(a) maintaining thermal contact between the one or more rotatable elements and the solid surface;
(b) maintaining thermal contact between the one or more rotatable elements and the liquid by passing the liquid across the surface of the one or more rotatable elements; and
(c) rotating the one or more rotatable elements, wherein rotation of each of the rotatable elements comprises rolling across the solid surface,
   whereby heat is transferred from the solid surface to the one or more rotatable elements and from the one or more rotatable elements to the liquid.

In another embodiment there is provided a method for transferring heat between a solid surface and a fluid (e.g. a gas or liquid) having a different temperature to the solid surface, wherein said method comprises providing a plurality of rotatable elements and a plurality of additional rotatable elements that are not in physical contact with said solid surface, and further comprising the simultaneous steps of:
(a) maintaining thermal contact between the rotatable elements and the solid surface;
(b) maintaining thermal contact between the rotatable elements and the fluid by passing the fluid across the surface of the one or more rotatable elements;
(c) rotating the rotatable elements, wherein rotation of each of the rotatable elements comprises rolling across the solid surface;
(d) maintaining thermal contact between the one or more additional rotatable elements and the fluid;
(e) maintaining thermal contact between the one or more additional rotatable elements and the one or more rotatable elements; and
(f) rotating the one or more additional rotatable elements.
   whereby either (i) heat is transferred from the solid surface to the one or more rotatable elements and from the one or more rotatable elements to the one or more additional rotatable elements and from the one or more additional rotatable elements to the fluid; or (ii) heat is transferred from the fluid to the one or more additional rotatable elements and from the one or more additional rotatable elements to the one or more rotatable elements and from the one or more rotatable elements to the solid surface.

According to a third aspect of the present invention there is provided a device for transferring heat between a first material having a first temperature and a second material having a second temperature, wherein said first temperature is greater than said second temperature, said device comprising one or more rotatable elements, said rotatable elements being arranged such that a heat transfer portion thereof is thermally contactable with both said first material and said second material, whereby rotation of said one or more rotatable elements transfers heat from said first material to said heat transfer portion and from said heat transfer portion to said second material.

The following options may be used in combination with the above aspect, either individually or in any suitable combination.

Each of the rotatable elements may be substantially cylindrical. Each of the rotatable elements may be substantially spherical. Each may be a rolling element.

Each of the rotatable elements may comprise a material having a thermal conductivity greater than about 0.001 W(m·K)⁻¹. Each of the rotatable elements may comprise, or consist essentially of, a material having a thermal conductivity between about 0.001 and about 10000 W(m·K)⁻¹. For example, each of the rotatable elements may comprise, or consist essentially of, a material having a thermal conductivity between about 1 and about 1000 W(m·K)⁻¹, or between about 10 and about 100 W(m·K)⁻¹. Each of the rotatable elements may comprise a material having a heat capacity greater than about 0.1 J(g·K)⁻¹. Each of the rotatable elements may comprise, or consist essentially of, a material having a heat capacity between about 0.1 and about 15 J(g·K)⁻¹. For example, each of the rotatable elements may comprise, or consist essentially of, a material having a heat capacity between about 1 and about 15 J(g·K)⁻¹, or between about 5 and about 10 J(g·K)⁻¹.

Each of the rotatable elements may have a core of a core material and a shell of a shell material. The core material may have a lower thermal conductivity than the shell material. The core material may have a lower heat capacity than the shell material.

At least one of the first material and the second material may comprise a solid surface. At least a portion of the solid surface may be concave. At least a portion of the solid surface may be convex. At least a portion of the solid surface may be flat. The solid surface may comprise holes through which the material can pass.

The rotatable elements may be constrained between the solid surface and a second surface, wherein the second surface is able to move relative to the solid surface. The relative movement of the second surface may cause the rotation of the rotatable elements.

A turbine may be mounted to the second surface, such that, in use, the turbine causes the second surface to move relative to the solid surface.

The second surface may comprise holes through which the material can pass. The solid surface and the second surface may be the inner and outer surfaces of concentric tubes or sections thereof. The solid surface and the second surface may be substantially fiat. The solid surface may have one or more circular grooves therein, said second surface being able to rotate relative to said solid surface, or said solid surface being able to rotate relative to said second surface, the axis of said rotation passing through the centre of said circular groove(s). The second surface may have one or more circular grooves therein.

The device may further comprise one or more additional rotatable elements one or more additional rotatable elements that are thermally contactable with the one or more rotatable elements but not in thermal contact with one of the first material and said second material. Rotation of the one or more additional rotatable elements may additionally transfer heat from the first material to the one or more additional rotatable elements and from the one or more additional rotatable elements to the one or more rotatable elements. Rotation of the one or more additional rotatable elements may additionally transfer heat from the second material to the one or more additional rotatable elements and from the one or more additional rotatable elements to the one or more rotatable elements. Rotation of the one or more rotatable elements may cause rotation of the one or more additional rotatable elements. Rotation of the one or more additional rotatable elements may cause rotation of the one or more rotatable elements.

The device may further comprise a pump for pumping a fluid across the surface of and/or through the one or more rotatable elements.

The device of the third aspect may be used for conducting the method of the first or second aspect.

According to a fourth aspect of the present invention there is provided a device for transferring heat between a solid surface and a material having a different temperature to said solid surface, wherein said device comprises one or more rotatable elements in thermal contact with said solid surface and said material, whereby rotation of said one or more rotatable elements either (i) transfers heat from the solid surface to the one or more rotatable elements and from the one or more rotatable elements to the material; or (ii) transfers heat from the material to the one or more rotatable elements and from the one or more rotatable elements to the solid surface.

The following options may be used in combination with the above aspect, either individually or in any suitable combination.

Each of the rotatable elements may be substantially cylindrical. Each of the rotatable elements may be substantially spherical. Each of the rotatable elements may be a rolling element.

Each of the rotatable elements may comprise a material having a thermal conductivity greater than about 0.001 W(m·K)⁻¹. Each of the rotatable elements may comprise a material having a thermal conductivity between about 0.001 and about 10000 W(m·K)⁻¹. For example, each of the rotatable elements may comprise, or consist essentially of, a material having a thermal conductivity between about 1 and about 1000 W(m·K)⁻¹, or between about 10 and about 100 W(m·K)⁻¹.

Each of the rotatable elements may comprise a material having a heat capacity greater than about 0.1 J(g·K)⁻¹. Each of the rotatable elements may comprise a material having a heat capacity between about 0.1 and about 15 J(g·K)⁻¹. For example, each of the rotatable elements may comprise, or consist essentially of, a material having a heat capacity between about 1 and about 15 J(g·K)⁻¹, or between about 5 and about 10 J(g·K)⁻¹.

Each of the rotatable elements may have a core of a first material and a shell of a second material. The first material may have a lower thermal conductivity than the second material. The first material may have a lower heat capacity than the second material.

At least a portion of the solid surface may be concave. At least a portion of the solid surface may be convex. At least a portion of the solid surface may be flat. The solid surface may comprise holes through which the material can pass.

The rotatable elements may be constrained between the solid surface and a second surface, wherein the second surface is able to move relative to the solid surface. The relative movement of the second surface may cause the rotation of the rotatable elements.

A turbine may be mounted to the second surface, such that, in use, the turbine causes the second surface to move relative to the solid surface.

The second surface may comprise holes through which the material can pass. The solid surface and the second surface may be the inner and outer surfaces of concentric tubes or sections thereof.

The solid surface and the second surface may be substantially flat. The solid surface may have one or more circular grooves therein, said second surface being able to rotate relative to said solid surface, or said solid surface being able to rotate relative to said second surface, the axis of said rotation passing through the centre of said circular groove(s). The second surface may have one or more circular grooves therein.

The device may further comprise one or more additional rotatable elements in thermal contact with the one or more rotatable elements and the material but not in physical contact with the solid surface. Rotation of the one or more additional rotatable elements may additionally transfer heat from the one or more rotatable elements to the one or more additional rotatable elements and from the one or more additional rotatable elements to the material. Rotation of the one or more additional rotatable elements may additionally transfer heat from the material to the one or more additional rotatable elements and from the one or more additional rotatable elements to the one or more rotatable elements. Rotation of the one or more rotatable elements may cause rotation of the one or more additional rotatable elements. Rotation of the one or more additional rotatable elements may cause rotation of the one or more rotatable elements.

The device may further comprise a pump for pumping the material across the surface of and/or through the one or more rotatable elements.

In an embodiment there is provided a device for transferring heat between a solid surface and a fluid having a different temperature to the solid surface, wherein said device comprises one or more rotatable elements in thermal contact with the solid surface and the fluid, wherein the rotatable elements are substantially spherical or substantially cylindrical, whereby rotation of the one or more rotatable elements either (i) transfers heat from the solid surface to the one or more rotatable elements and from the one or more rotatable elements to the fluid; or (ii) transfers heat from the fluid to the one or more rotatable elements and from the one or more rotatable elements to the solid surface.

In another embodiment there is provided a device for transferring heat between a solid surface and a fluid having a different temperature to the solid surface, wherein said device comprises a plurality of rotatable elements in thermal contact with the solid surface and the fluid, wherein the rotatable elements are substantially spherical or substantially cylindrical and are constrained between the solid surface and a second surface, whereby rotation of the rotatable elements either (i) transfers heat from the solid surface to the one or more rotatable elements and from the rotatable elements to the fluid; or (ii) transfers heat from the fluid to the rotatable elements and from the rotatable elements to the solid surface.

In another embodiment there is provided a device for transferring heat between a solid surface and a fluid having a different temperature to the solid surface, wherein said device comprises a plurality of rotatable elements in thermal contact with the solid surface and the fluid, wherein the rotatable elements are substantially spherical or substantially cylindrical and wherein the rotatable elements are constrained between the solid surface and a second surface, the second surface being able to move relative to the solid surface thereby causing rotation of the rotatable elements, such that the rotation of the rotatable elements either (i) transfers heat from the solid surface to the one or more rotatable elements and from the one or more rotatable elements to the fluid; or (ii) transfers heat from the fluid to the one or more rotatable elements and from the one or more rotatable elements to the solid surface.

The device of the fourth aspect may be used for conducting the method of the first or second aspect.

### BRIEF DESCRIPTION OF THE DRAWINGS

Embodiments of the present invention will now be described, by way of an example only, with reference to the accompanying drawings wherein:

FIG. 1 illustrates a device for transferring heat according to an embodiment of the invention, wherein a plurality of rotatable elements is mounted on the interior surface of a pipe;

FIG. 2 illustrates a device for transferring heat according to an embodiment of the invention, wherein a plurality of rotatable elements is mounted inside a pipe having a flared section;

FIG. 3 illustrates a device for transferring heat according to an embodiment of the invention, wherein a series of circularly arranged arrays of rotatable elements are provided;

FIG. 4a illustrates a device for transferring heat according to an embodiment of the invention that may be retrofitted to an existing pipe;

FIG. 4b illustrates a series of the devices of FIG. 4a mounted inside a pipe;

FIG. 5 illustrates a device for transferring heat according to an embodiment of the invention comprising an internally mounted turbine;

FIG. 6 illustrates a device for transferring heat according to an embodiment of the invention, wherein a plurality of rotatable elements is mounted on the exterior surface of a pipe;

FIG. 7a illustrates a device for transferring heat according to an embodiment of the invention for transferring heat away from a heat source;

FIG. 7b is a top cross-section view of an embodiment of the device of FIG. 7a that includes a plurality of rotatable elements in each groove of the base plate;

FIG. 7c illustrates an embodiment of the device of FIG. 7a having middle plates mounted between the base plate and top plate;

FIG. 8a illustrates a device for transferring heat according to an embodiment of the invention comprising a plurality of rotatable elements mounted on shafts;

FIG. 8b illustrates an embodiment of the device of FIG. 8a, wherein the rotatable elements are in thermal contact with a second surface;

FIG. 8c illustrates an embodiment of the device of FIG. 8a, wherein the rotatable elements are in thermal contact with a second surface and a third surface;

FIG. 9a illustrates a device for transferring heat between two fluids according to an embodiment of the invention comprising discs mounted between two chambers;

FIG. 9b is a top cross-section view of the device of FIG. 9a;

FIG. 9c is a front cross-section view of the device of FIG. 9a;

FIG. 10 illustrates a device for transferring heat according to an embodiment of the invention comprising a rotatable element mounted between two solid surfaces;

FIG. 11 shows a heat sink device for transferring heat according to an embodiment of the invention;

FIG. 12 is a graph of the temperature of the device of FIG. 11 as a function of time;

FIG. 13a shows a disassembled tubular heat exchanger device according to an embodiment of the invention;

FIG. 13b shows the assembly of the tubular heat exchanger device of FIG. 13a;

FIG. 13c shows the tubular heat exchanger device of FIG. 13a after assembly;

FIG. 14 is a graph showing the measured heat transfer coefficient, h, as a function of rotation rate for the device of FIG. 13a; and

FIG. 15 is a graph showing the relative heat transfer efficiency of the device of FIG. 13a.

### DETAILED DESCRIPTION OF THE PREFERRED EMBODIMENTS

Disclosed herein is a new method of transferring heat between two materials having different temperatures. The new method of heat transfer utilises rotating elements as intermediaries between the two materials, combining with other heat transfer mechanism(s) to increase the efficiency of heat transfer.

In accordance with the present invention, rotatable elements are used as intermediaries in the transfer of heat between a first material and a second material, wherein the temperature of the first material is greater than that of the second material.

As used herein, the term “heat transfer” means the movement of thermal energy from one material to another by thermal contact therewith. As used herein, the terms “thermally contacting”, “thermally contactable” and “thermal contact” describe any contact wherein heat may be transferred, whether by direct physical contact between two materials or via one or more other materials (i.e., by conduction, convection or radiation), and/or by radiation.

The rotatable elements are arranged so that, on rotation, at least a portion thereof (i.e., a point, area or volume) is thermally contactable with both the first material and the second material. For example, where a rotatable element is disposed at the interface between the first material and second material, the axis of rotation of the rotatable element must have a component that lies within the plane of that interface (i.e., the axis of rotation cannot be exactly perpendicular to the interfacial plane). Thus, rotation of the rotatable elements brings the thermally contactable portion thereof sequentially into greater and lesser thermal contact with the first material. Rotation of the rotatable elements also brings the thermally contactable portion thereof sequentially into greater and lesser thermal contact with the second material. In both cases, bringing the thermally contactable portion into lesser thermal contact may include breaking thermal contact.

While the surface of each of the rotatable elements is stationary relative to the first material and second material, the main mechanism of heat transfer is conduction. However, while the rotatable elements are rotating, such that the position of the thermally contactable portion relative to the first material and/or second material alters with time, the efficiency of heat transfer benefits from the rotational motion and possibly also the differential temperature within the rotatable elements. Furthermore, the heat transfer efficiency may be adjusted by subjecting the rotatable elements to faster or slower rates of rotation. Where the first material comprises a solid surface and/or the second material comprises a solid surface, the heat transfer efficiency may be adjusted by adjusting the pressure between the rotatable elements and the solid surface(s) (thereby altering the surface area of contact).

In applications of the methods and devices of the invention, the first material may be used to heat the second material. Conversely, in other applications the second material may be used to cool the first material.

### First Material and Second Material

In accordance with the present invention, heat is transferred from the first material to the second material. As used herein, the term “material” when used in the context of heat transfer to or from said “material” may refer to either the first material or second material as described herein.

Both the first material and second material may comprise any suitable material(s). The first material and/or the second material may comprise a solid. The first material and/or the second material may comprise a fluid.

Either, or both, the first material and the second material may comprise a solid surface. As used herein, the term “solid surface” includes any solid surface and semi-solid surface of any material.

The solid surface may be the surface of any suitable solid and/or semi-solid material or materials. The solid surface may be constructed of same material across its entire area. Alternatively, the solid surface may be constructed of a combination of materials.

The material from which the solid surface is constructed may be deformable or substantially rigid under operative conditions. The solid surface may be constructed entirely of a substantially rigid material or materials. The solid surface may be constructed entirely of a deformable material or materials. The solid surface may comprise a combination of deformable and substantially rigid materials.

Where the solid surface comprises a deformable material or materials, the deformable material or materials may be elastic. The solid surface may be constructed entirely of an elastic material or materials. The elastic material may have any suitable Young's modulus. The Young's modulus of the elastic material or materials may be greater than about 0.01, 0.05, 1, 5, 10, 50, 100, 500 or 1000 GPa. The Young's modulus of the elastic material or materials may be between about 0.01 and about 0.05, 1, 5, 10, 50, 100, 500 or 1000 GPa; between about 0.05 and about 1, 5, 10, 50, 100, 500 or 1000 GPa; between about 1 and about 5, 10, 50, 100, 500 or 1000 GPa; between about 5 and about 10, 50, 100, 500 or 1000 GPa; between about 10 and about 50, 100, 500 or 1000 GPa; between about 50 and about 100, 500 or 1000 GPa; between about 100 and about 500 or 1000 GPa; or between about 500 and 1000 GPa. The Young's modulus of the elastic material or materials may be about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 or 1000 GPa.

The solid surface may comprise a material that has any suitable static frictional co-efficient. The solid surface may comprise a material with a static frictional co-efficient sufficient to inhibit of substantially prevent slippage between the rotatable elements and the solid surface. The static frictional co-efficient of the solid surface may be greater than about 0.1, 0.2, 0.3, 0.4, 0.5, 0.6, 0.7, 0.8, 0.9, 1.0, 1.1, 1.2, 1.3 or 1.4. The static frictional co-efficient of the solid surface may be between about 0.1 and about 0.2, 0.3, 0.4, 0.5, 0.6, 0.7, 0.8, 0.9, 1.0, 1.1, 1.2, 1.3 or 1.4; between about 0.2 and about 0.3, 0.4, 0.5, 0.6, 0.7, 0.8, 0.9, 1.0, 1.1, 1.2, 1.3 or 1.4; between about 0.3 and about 0.4, 0.5, 0.6, 0.7, 0.8, 0.9, 1.0, 1.1, 1.2, 1.3 or 1.4; between about 0.4 and about 0.5, 0.6, 0.7, 0.8, 0.9, 1.0, 1.1, 1.2, 1.3 or 1.4; between about 0.5 and about 0.6, 0.7, 0.8, 0.9, 1.0, 1.1, 1.2, 1.3 or 1.4; between about 0.6 and about 0.7, 0.8, 0.9, 1.0, 1.1, 1.2, 1.3 or 1.4; between about 0.7 and about 0.8, 0.9, 1.0, 1.1, 1.2, 1.3 or 1.4; between about 0.8 and about 0.9, 1.0, 1.1, 1.2, 1.3 or 1.4; between about 0.9 and about 1.0, 1.1, 1.2, 1.3 or 1.4; between about 1.0 and about 1.1, 1.2, 1.3 or 1.4; between about 1.1 and about 1.2, 1.3 or 1.4; between about 1.2 and about 1.3 or 1.4; or between about 1.3 and about 1.4. The static frictional co-efficient of the solid surface may be about 0.1, 0.2, 0.3, 0.4, 0.5, 0.6, 0.7, 0.8, 0.9, 1.0, 1.1, 1.2, 1.3 or 1.4. The static frictional co-efficient of the solid surface may be constant across the entire solid surface. Alternatively, the static frictional co-efficient may vary across the solid surface.

Suitable materials for the solid surface include, but are not limited to, metals, polymers, ceramics, minerals and composite materials and combinations of any two or more of these. Suitable metals for the solid surface include, but are not limited to, stainless steel, steel, tin, nickel, aluminium, brass, iron, copper and lead. Suitable polymers for the solid surface include but are not limited to, polypropylene, polyvinyl chloride, polyethylene, polystyrene and polyethylene terephthalate. Suitable ceramics for the solid surface include, but are not limited to, silicon nitride and ferrite. Suitable minerals for the solid surface include, but are not limited to, graphite and quartz Suitable composite materials for the solid surface include, but are not limited to, polymer-metal composites and ceramic filled polymers. Suitable materials may be resistant to degradation, may not melt and/or may not soften under operative conditions.

The solid surface may have any suitable geometry. The solid surface may be concave. The solid surface may be convex. The solid surface may be flat. The solid surface may be any combination of the foregoing.

The area of the solid surface may be any suitable size. The solid surface may be a portion of a larger solid surface.

The solid surface may be the surface an object such as a heat source or a heat sink. For example, the solid surface may be the inner surface of a pipe, the outer surface of a pipe (such as the outer surface of a drum in a clothes dryer), the surface of a central processing unit of a computer or a heating plate (such as that used in floor heating or cooking).

The solid surface may be static while the rotatable elements are rotated relative to the solid surface. The solid surface may be passed across the surface while the rotatable elements are rotating. The solid surface may be passed across the rotatable elements while the rotatable elements are stationary so as to effect rotation of the rotatable elements relative to the solid surface. The solid surface may be passed across the surface of the rotatable elements by any suitable means. For example, the fluid may be passed across the surface of or through the rotatable elements by pumping. For example, the solid surface rotation may be passed across the surface of the rotatable elements by a motor, such as an AC motor, a DC motor, a magnetic field motor or a heat engine (such as an internal combustion engine, a diesel engine or a steam engine).

Either, or both, the first material and the second material may comprise a fluid. The fluid may be a gas. The fluid may be a liquid. The fluid may be a vapour. The fluid may comprise solid particles. The fluid may be a combination of the foregoing. For example, the fluid may be a dispersion, such as a suspension, sol, emulsion, foam, gel or aerosol. The fluid may be a heat transfer fluid. The fluid may be a refrigerant. The fluid may be air, water, a silicone, a liquid hydrocarbon or a gaseous hydrocarbon. The fluid may be an air-water mixture.

The fluid may be passed across the surface of or through the rotatable elements while the rotatable elements are rotating. The fluid may be passed across the surface of or through the rotatable elements by any suitable means. For example, the fluid may be passed across the surface of or through the rotatable elements by pumping. The fluid may be pumped by any suitable means known in the art, such as by a centrifugal pump, axial flow pump, mixed flow pump, eductor-jet pump or peristaltic pump. The fluid may be passed across the surface of or through the rotatable elements by an external means (e.g. the fluid is naturally flowing under gravity or is being pumped by another device or as a part another method or process).

The thermal conductivity of the first material may play an important role in determining the rate of heat transfer between the first material and the rotatable element(s). The thermal conductivity of the second material may play an important role in determining the rate of heat transfer between the second material and the rotatable element(s). The first material and/or second material may have any suitable thermal conductivity. The first material and/or second material may have a thermal conductivity at 25° C. greater than about 0.001, 0.005, 0.01, 0.05, 0.1, 0.5, 1, 5, 10, 50, 100, 500, 1000, 5000 or 10000 W(m·K)⁻¹. The first material and/or second material may have a thermal conductivity at 25° C. between about 0.001 and about 0.005, 0.01, 0.05, 0.1, 0.5, 1, 5, 10, 50, 100, 500, 1000, 5000 or 10000 W(m·K)⁻¹; between about 0.005 and about 0.01, 0.05, 0.1, 0.5, 1, 5, 10, 50, 100, 500, 1000, 5000 or 10000 W(m·K)⁻¹; between about 0.01 and about 0.05, 0.1, 0.5, 1, 5, 10, 50, 100, 500, 1000, 5000 or 10000 W(m·K)⁻¹; between about 0.05 and about 0.1, 0.5, 1, 5, 10, 50, 100, 500, 1000, 5000 or 10000 W(m·K)⁻¹; between about 0.1 and about 0.5, 1, 5, 10, 50, 100, 500, 1000, 5000 or 10000 W(m·K)⁻¹; between about 0.5 and about 1, 5, 10, 50, 100, 500, 1000, 5000 or 10000 W(m·K)⁻¹; between about 1 and about 5, 10, 50, 100, 500, 1000, 5000 or 10000 W(m·K)⁻¹; between about 5 and about 10, 50, 100, 500, 1000, 5000 or 10000 W(m·K)⁻¹; between about 10 and about 50, 100, 500, 1000, 5000 or 10000 W(m·K)⁻¹; between about 50 and about 100, 500, 1000, 5000 or 10000 W(m·K)⁻¹; between about 100 and about 500, 1000, 5000 or 10000 W(m·K)⁻¹; between about 500 and about 1000, 5000 or 10000 W(m·K)⁻¹; between about 1000 and about 5000 or 10000 W(m·K)⁻¹; or between about 5000 and about 10000 W(m·K)⁻¹. The first material and/or second material may have a thermal conductivity at 25° C. of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000 or 10000 W(m·K)⁻¹.

The heat capacity of the first material may play an important role in determining the rate of heat transfer between the first material and the rotatable element(s). The heat capacity of the second material may play an important role in determining the rate of heat transfer between the rotatable element(s) and the second material. The first material and/or second material may have any suitable heat capacity. The first material and/or second material may have a heat capacity at 25° C. greater than about 0.1, 0.2, 0.3, 0.4, 0.5, 0.6, 0.7, 0.8, 0.9, 1, 2, 3, 4, 5, 6, 7, 8, 9, 10, 11, 12, 13, 14 or 15 J(g·K)⁻¹. The material may have a heat capacity at 25° C. of between about 0.1 and about 0.2, 0.3, 0.4, 0.5, 0.6, 0.7, 0.8, 0.9, 1, 2, 3, 4, 5, 6, 7, 8, 9, 10, 11, 12, 13, 14 or 15 J(g·K)⁻¹; between about 0.2 and about 0.3, 0.4, 0.5, 0.6, 0.7, 0.8, 0.9, 1, 2, 3, 4, 5, 6, 7, 8, 9, 10, 11, 12, 13, 14 or 15 J(g·K)⁻¹; between about 0.3 and about 0.4, 0.5, 0.6, 0.7, 0.8, 0.9, 1, 2, 3, 4, 5, 6, 7, 8, 9, 10, 11, 12, 13, 14 or 15 J(g·K)⁻¹; between about 0.4 and about 0.5, 0.6, 0.7, 0.8, 0.9, 1, 2, 3, 4, 5, 6, 7, 8, 9, 10, 11, 12, 13, 14 or 15 J(g·K)⁻¹; between about 0.5 and about 0.6, 0.7, 0.8, 0.9, 1, 2, 3, 4, 5, 6, 7, 8, 9, 10, 11, 12, 13, 14 or 15 J(g·K)⁻¹; between about 0.6 and about 0.7, 0.8, 0.9, 1, 2, 3, 4, 5, 6, 7, 8, 9, 10, 11, 12, 13, 14 or 15 J(g·K)⁻¹; between about 0.7 and about 0.8, 0.9, 1, 2, 3, 4, 5, 6, 7, 8, 9, 10, 11, 12, 13, 14 or 15 J(g·K)⁻¹; between about 0.7 and about 0.8, 0.9, 1, 2, 3, 4, 5, 6, 7, 8, 9, 10, 11, 12, 13, 14 or 15 J(g·K)⁻¹; between about 0.8 and about 0.9, 1, 2, 3, 4, 5, 6, 7, 8, 9, 10, 11, 12, 13, 14 or 15 J(g·K)⁻¹; between about 0.9 and about 1, 2, 3, 4, 5, 6, 7, 8, 9, 10, 11, 12, 13, 14 or 15 J(g·K)⁻¹; between about 1 and about 2, 3, 4, 5, 6, 7, 8, 9, 10, 11, 12, 13, 14 or 15 J(g·K)⁻¹; between about 2 and about 3, 4, 5, 6, 7, 8, 9, 10, 11, 12, 13, 14 or 15 J(g·K)⁻¹; between about 3 and about 4, 5, 6, 7, 8, 9, 10, 11, 12, 13, 14 or 15 J(g·K)⁻¹; between about 4 and about 5, 6, 7, 8, 9, 10, 11, 12, 13, 14 or 15 J(g·K)⁻¹; between about 5 and about 6, 7, 8, 9, 10, 11, 12, 13, 14 or 15 J(g·K)⁻¹; between about 6 and about 7, 8, 9, 10, 11, 12, 13, 14 or 15 J(g·K)⁻¹; between about 7 and about 8, 9, 10, 11, 12, 13, 14 or 15 J(g·K)⁻¹; between about 8 and about 9, 10, 11, 12, 13, 14 or 15 J(g·K)⁻¹; between about 9 and about 10, 11, 12, 13, 14 or 15 J(g·K)⁻¹; between about 10 and about 11, 12, 13, 14 or 15 J(g·K)⁻¹; between about 11 and about 12, 13, 14 or 15 J(g·K)⁻¹; between about 12 and about 13, 14 or 15 J(g·K)⁻¹; between about 13 and about 14 or 15 J(g·K)⁻¹; or between about 14 and 15 J(g·K)⁻¹. The first material and/or second material may have a heat capacity at 25° C. of about 0.1, 0.2, 0.3, 0.4, 0.5, 0.6, 0.7, 0.8, 0.9, 1, 2, 3, 4, 5, 6, 7, 8, 9, 10, 11, 12, 13, 14 or 15 J(g·K)⁻¹.

The first material and/or second material may have a high thermal conductivity and high heat capacity. The first material and/or second material may have a high thermal conductivity and low heat capacity. The first material and/or second material may have a low thermal conductivity and high heat capacity. The first material and/or second material may have a low thermal conductivity and low heat capacity.

### Rotatable Elements

The rotatable elements act as intermediaries in the transfer of heat from the first material to the second material.

At least a portion of the rotatable elements, the heat transfer portion, is thermally contactable with both the first material and second material. Heat transfer from the first material to the heat transfer portion is effected by thermal contact therebetween and heat transfer from the heat transfer portion to the second material is effected by thermal contact therebetween. Thermal contact may be maintained between the heat transfer portion and both the first material and second material simultaneously, provided rotation of the rotatable elements alters the rate of heat transfer from the first material to the heat transfer portion and/or from the heat transfer portion to the second material.

A rotatable element may come into direct physical contact with the first material and/or second material during rotation. Where a rotatable element comes into direct physical contact with a solid surface, the rotatable element may slide across the solid surface or roll across the solid surface. Where a rotatable element rolls across a solid surface and may be referred to as a “rolling element”.

Where more than one rotatable element is present, one or more (including all) rotatable elements may be in contact with one or more adjacent rotatable elements. Alternatively, each rotatable element may have no physical contact with any adjacent rotatable elements.

Where more than one rotatable element is present, all of the rotatable elements may be constructed of the same material or materials. Alternatively, one or more of the rotatable elements may be constructed of different material or materials to one or more of the other rotatable elements.

A rotatable element may be constructed of any suitable material or materials. A rotatable element may be constructed of the same material throughout. A rotatable element may be constructed of a combination of materials. For example, a rotatable element may comprise a core of a core material surrounded by a shell of a shell material.

A rotatable element may comprise a gaseous core. A rotatable element may have a substantially empty (i.e., a vacuum) core. A rotatable element may comprise a liquid core. A rotatable element may comprise a solid core. A rotatable element may have a hollow core, thereby allowing passage of the first material, the second material or another material through the core of the rotatable element.

A rotatable element may have one or more holes through which the first material, the second material or another material may pass. A hole through a rotatable element may be any shape. For example, a hole through an elongate rotatable element may extend along the longitudinal axis and may be circular or star-shaped in cross-section. Such holes may increase the surface area of the rotatable element in contact with the first material or second material. An increase in contact area between the rotatable element and the first material or second material may affect the efficiency of heat transfer between the rotatable element and the first material or second material, respectively.

The material from which a rotatable element is constructed may be deformable or substantially rigid. A rotatable element may be constructed entirely of a substantially rigid material or materials. A rotatable element may be constructed entirely of a deformable material or materials. A rotatable element may comprise a combination of deformable and substantially rigid materials. A rotatable element may comprise a substantially rigid core and a deformable shell. A rotatable element may comprise a deformable shell and a substantially rigid core.

Where a rotatable element comprises a deformable material or materials, the rotatable element may comprise a deformable material that is elastic. A rotatable element may be constructed entirely of an elastic material or materials. A rotatable element may comprise a substantially rigid core and an elastic shell. A rotatable element may comprise an elastic core and a substantially rigid shell. The elastic material may have any suitable Young's modulus. The Young's modulus of the elastic material or materials may be greater than about 0.01, 0.05, 1, 5, 10, 50, 100, 500 or 1000 GPa. The Young's modulus of the elastic material or materials may be between about 0.01 and about 0.05, 1, 5, 10, 50, 100, 500 or 1000 GPa; between about 0.05 and about 1, 5, 10, 50, 100, 500 or 1000 GPa; between about 1 and about 5, 10, 50, 100, 500 or 1000 GPa; between about 5 and about 10, 50, 100, 500 or 1000 GPa; between about 10 and about 50, 100, 500 or 1000 GPa; between about 50 and about 100, 500 or 1000 GPa; between about 100 and about 500 or 1000 GPa; or between about 500 and 1000 GPa. The Young's modulus of the elastic material or materials may be about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 or 1000 GPa.

Where a rotatable element comprises a deformable shell or is constructed entirely of a deformable material, a pressure may be applied urging the rotatable element onto a solid surface causing the rotatable element to partially flatten against the solid surface. Such deformation of the rotatable element may vary the heat transfer efficiency between the solid surface and the rotatable element by increasing the area of contact between the two.

Where a rotatable element is contacting one or more adjacent rotatable elements and the rolling element comprises a deformable shell or is constructed entirely of a deformable material, a pressure may be applied urging the rotatable element onto the adjacent rotatable element(s) causing the rotatable element to partially flatten against the adjacent rotatable element(s).

The thermal conductivity of the rotatable element(s) may play an important role in determining the rate of heat transfer between the rotatable element(s) and the first material and the rotatable element(s) and the second material. A rotatable element may comprise a material that has any suitable thermal conductivity. A rotatable element may comprise a material that has a thermal conductivity at 25° C. greater than about 0.001, 0.005, 0.01, 0.05, 0.1, 0.5, 1, 5, 10, 50, 100, 500, 1000, 5000 or 10000 W(m·K)⁻¹. A rotatable element may comprise a material that has a thermal conductivity at 25° C. between about 0.001 and about 0.005, 0.01, 0.05, 0.1, 0.5, 1, 5, 10, 50, 100, 500, 1000, 5000 or 10000 W(m·K)⁻¹; between about 0.005 and about 0.01, 0.05, 0.1, 0.5, 1, 5, 10, 50, 100, 500, 1000, 5000 or 10000 W(m·K)⁻¹; between about 0.01 and about 0.05, 0.1, 0.5, 1, 5, 10, 50, 100, 500, 1000, 5000 or 10000 W(m·K)⁻¹; between about 0.05 and about 0.1, 0.5, 1, 5, 10, 50, 100, 500, 1000, 5000 or 10000 W(m·K)⁻¹; between about 0.1 and about 0.5, 1, 5, 10, 50, 100, 500, 1000, 5000 or 10000 W(m·K)⁻¹; between about 0.5 and about 1, 5, 10, 50, 100, 500, 1000, 5000 or 10000 W(m·K)⁻¹; between about 1 and about 5, 10, 50, 100, 500, 1000, 5000 or 10000 W(m·K)⁻¹; between about 5 and about 10, 50, 100, 500, 1000, 5000 or 10000 W(m·K)⁻¹; between about 10 and about 50, 100, 500, 1000, 5000 or 10000 W(m·K)⁻¹; between about 50 and about 100, 500, 1000, 5000 or 10000 W(m·K)⁻¹; between about 100 and about 500, 1000, 5000 or 10000 W(m·K)⁻¹; between about 500 and about 1000, 5000 or 10000 W(m·K)⁻¹; between about 1000 and about 5000 or 10000 W(m·K)⁻¹; or between about 5000 and about 10000 W(m·K)⁻¹. A rotatable element may comprise a material that has a thermal conductivity at 25° C. of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000 or 10000 W(m·K)⁻¹. The thermal conductivity of a rotatable element may be constant throughout the rotatable element. Alternatively, the thermal conductivity may vary throughout the rotatable element.

The heat capacity of the rotatable element(s) may play an important role in determining the rate of heat transfer between the rotatable element(s) and the first material and the rotatable element(s) and the second material. A rotatable element may comprise a material that has any suitable heat capacity. A rotatable element may comprise a material that has a heat capacity at 25° C. greater than about 0.1, 0.2, 0.3, 0.4, 0.5, 0.6, 0.7, 0.8, 0.9, 1, 2, 3, 4, 5, 6, 7, 8, 9, 10, 11, 12, 13, 14 or 15 J(g·K)⁻¹. A rotatable element may comprise a material that has a heat capacity at 25° C. of between about 0.1 and about 0.2, 0.3, 0.4, 0.5, 0.6, 0.7, 0.8, 0.9, 1, 2, 3, 4, 5, 6, 7, 8, 9, 10, 11, 12, 13, 14 or 15 J(g·K)⁻¹; between about 0.2 and about 0.3, 0.4, 0.5, 0.6, 0.7, 0.8, 0.9, 1, 2, 3, 4, 5, 6, 7, 8, 9, 10, 11, 12, 13, 14 or 15 J(g·K)⁻¹; between about 0.3 and about 0.4, 0.5, 0.6, 0.7, 0.8, 0.9, 1, 2, 3, 4, 5, 6, 7, 8, 9, 10, 11, 12, 13, 14 or 15 J(g·K)¹; between about 0.4 and about 0.5, 0.6, 0.7, 0.8; 0.9, 1, 2, 3, 4, 5, 6, 7, 8, 9, 10, 11, 12, 13, 14 or 15 J(g·K)⁻¹; between about 0.5 and about 0.6, 0.7, 0.8, 0.9, 1, 2, 3, 4, 5, 6, 7, 8, 9, 10, 11, 12, 13, 14 or 15 J(g·K)⁻¹; between about 0.6 and about 0.7, 0.8, 0.9, 1, 2, 3, 4, 5, 6, 7, 8, 9, 10, 11, 12, 13, 14 or 15 J(g·K)⁻¹; between about 0.7 and about 0.8, 0.9, 1, 2, 3, 4, 5, 6, 7, 8, 9, 10, 11, 12, 13, 14 or 15 J(g·K)⁻¹; between about 0.7 and about 0.8, 0.9, 1, 2, 3, 4, 5, 6, 7, 8, 9, 10, 11, 12, 13, 14 or 15 J(g·K)⁻¹; between about 0.8 and about 0.9, 1, 2, 3, 4, 5, 6, 7, 8, 9, 10, 11, 12, 13, 14 or 15 J(g·K)⁻¹; between about 0.9 and about 1, 2, 3, 4, 5, 6, 7, 8, 9, 10, 11, 12, 13, 14 or 15 J(g·K)⁻¹; between about 1 and about 2, 3, 4, 5, 6, 7, 8, 9, 10, 11, 12, 13, 14 or 15 J(g·K)⁻¹; between about 2 and about 3, 4, 5, 6, 7, 8, 9, 10, 11, 12, 13, 14 or 15 J(g·K)⁻¹; between about 3 and about 4, 5, 6, 7, 8, 9, 10, 11, 12, 13, 14 or 15 J(g·K)⁻¹; between about 4 and about 5, 6, 7, 8, 9, 10, 11, 12, 13, 14 or 15 J(g·K)⁻¹; between about 5 and about 6, 7, 8, 9, 10, 11, 12, 13, 14 or 15 J(g·K)⁻¹; between about 6 and about 7, 8, 9, 10, 11, 12, 13, 14 or 15 J(g·K)⁻¹; between about 7 and about 8, 9, 10, 11, 12, 13, 14 or 15 J(g·K)⁻¹; between about 8 and about 9, 10, 11, 12, 13, 14 or 15 J(g·K)⁻¹; between about 9 and about 10, 11, 12, 13, 14 or 15 J(g·K)⁻¹; between about 10 and about 11, 12, 13, 14 or 15 J(g·K)⁻¹; between about 11 and about 12, 13, 14 or 15 J(g·K)⁻¹; between about 12 and about 13, 14 or 15 J(g·K)⁻¹; between about 13 and about 14 or 15 J(g·K)⁻¹; or between about 14 and 15 J(g·K)⁻¹. A rotatable element may comprise a material that has a heat capacity at 25° C. of about 0.1, 0.2, 0.3, 0.4, 0.5, 0.6, 0.7, 0.8, 0.9, 1, 2, 3, 4, 5, 6, 7, 8, 9, 10, 11, 12, 13, 14 or 15 J(g·K)⁻¹. The heat capacity of a rotatable element may be constant throughout the rotatable element. Alternatively, the heat capacity may vary throughout the rotatable element.

The rotatable element(s) may comprise a material having a high thermal conductivity and high heat capacity. The rotatable element(s) may comprise a material having a high thermal conductivity and low heat capacity. The rotatable element(s) may comprise a material having a low thermal conductivity and high heat capacity. The rotatable element(s) may comprise a material having a low thermal conductivity and low heat capacity.

Where a rotatable element comprises a core material and a shell material, the core material may have a higher thermal conductivity than the shell material. Alternatively, the core material may have a lower thermal conductivity than the shell material. Alternatively, the core material may have substantially the same thermal conductivity as the shell material. Furthermore, the core material may have a higher heat capacity than the shell material. Alternatively, the core material may have a lower heat capacity than the shell material. Alternatively, the core material may have substantially the same heat capacity as the shell material.

A rotatable element may comprise a material that has any suitable thermal static frictional co-efficient. The surface of a rotatable element may be constructed of a material that allows some slippage between the rotatable element and a solid surface and/or other rotatable element(s). The surface of a rotatable elements may be constructed of material with a static frictional co-efficient sufficient to substantially prevent slippage between the rotatable element and a solid surface and/or other rotatable element(s). The static frictional co-efficient of the surface of a rotatable elements may be greater than about 0.1, 0.2, 0.3, 0.4, 0.5, 0.6, 0.7, 0.8, 0.9, 1.0, 1.1, 1.2, 1.3 or 1.4. The static frictional co-efficient of the surface of a rotatable element may be between about 0.1 and about 0.2, 0.3, 0.4, 0.5, 0.6, 0.7, 0.8, 0.9, 1.0, 1.1, 1.2, 1.3 or 1.4; between about 0.2 and about 0.3, 0.4, 0.5, 0.6, 0.7, 0.8, 0.9, 1.0, 1.1, 1.2, 1.3 or 1.4; between about 0.3 and about 0.4, 0.5, 0.6, 0.7, 0.8, 0.9, 1.0, 1.1, 1.2, 1.3 or 1.4; between about 0.4 and about 0.5, 0.6, 0.7, 0.8, 0.9, 1.0, 1.1, 1.2, 1.3 or 1.4; between about 0.5 and about 0.6, 0.7, 0.8, 0.9, 1.0, 1.1, 1.2, 1.3 or 1.4; between about 0.6 and about 0.7, 0.8, 0.9, 1.0, 1.1, 1.2, 1.3 or 1.4; between about 0.7 and about 0.8, 0.9, 1.0, 1.1, 1.2, 1.3 or 1.4; between about 0.8 and about 0.9, 1.0, 1.1, 1.2, 1.3 or 1.4; between about 0.9 and about 1.0, 1.1, 1.2, 1.3 or 1.4; between about 1.0 and about 1.1, 1.2, 1.3 or 1.4; between about 1.1 and about 1.2, 1.3 or 1.4; between about 1.2 and about 1.3 or 1.4; or between about 1.3 and about 1.4. The static frictional co-efficient of the surface of a rotatable element may be constant across the entire surface of the rotatable element. Alternatively, the static frictional co-efficient may vary across the surface of each the rotatable element.

Suitable materials for the rotatable elements) include, but are not limited to, metals, polymers, ceramics, minerals and composite materials and combinations of any two or more of these. Suitable metals for the rotatable element(s) include, but are not limited to, stainless steel, steel, tin, nickel, aluminium, brass, iron, copper and lead. Suitable polymers for the rotatable element(s) include but are not limited to, polypropylene, polyvinyl chloride, polyethylene, polystyrene and polyethylene terephthalate. Suitable ceramics for the rotatable element(s) include, but are not limited to, silicon nitride and ferrite. Suitable minerals for the rotatable elements include, but are not limited to, graphite and quartz. Suitable composite materials for the rotatable element(s) include, but are not limited to, polymer-metal composites and ceramic filled polymers.

Where a rotatable element comprises a core of a core material surrounded by a shell of a shell material, the rotatable element may comprise a ceramic core and a metal shell. A rotatable element may comprise a ceramic core and a polymer shell. A rotatable element may comprise a ceramic core and a composite material shell. A rotatable element may comprise a ceramic core and a ceramic shell. A rotatable element may comprise a metal core and a metal shell. A rotatable element may comprise a metal core and a ceramic shell. A rotatable element may comprise a metal core and a polymer shell. A rotatable element may comprise a metal core and a composite material shell. A rotatable element may comprise a polymer core and a polymer shell. A rotatable element may comprise a polymer core and a metal shell. A rotatable element may comprise a polymer core and a ceramic shell. A rotatable element may comprise a polymer core and a composite material shell. A rotatable element may comprise a composite material core and a composite material shell. A rotatable element may comprise a composite material core and a metal shell. A rotatable element may comprise a composite material core and a ceramic shell. A rotatable element may comprise a composite material core and a polymer shell.

A rotatable element may, for example, comprise a silicon nitride core and a ferrite, stainless steel, steel, tin, nickel, aluminium, brass, iron, copper, lead, polypropylene, polyvinyl chloride, polyethylene, polystyrene, polyethylene terephthalate, graphite, quartz or polymer-metal composite shell; or a ferrite core and a silicon nitride, stainless steel, steel, tin, nickel, aluminium, brass, iron, copper, lead, polypropylene, polyvinyl chloride, polyethylene, polystyrene, polyethylene terephthalate, graphite, quartz or polymer-metal composite shell.

A rotatable element may, for example, comprise a stainless steel core and a silicon nitride, ferrite, steel, tin, nickel, aluminium, brass, iron, copper, lead, polypropylene, polyvinyl chloride, polyethylene, polystyrene, polyethylene terephthalate, graphite, quartz or polymer-metal composite shell; a steel core and a silicon nitride, ferrite, stainless steel, tin, nickel, aluminium, brass, iron, copper, lead, polypropylene, polyvinyl chloride, polyethylene, polystyrene, polyethylene terephthalate, graphite, quartz or polymer-metal composite shell; a tin core and a silicon nitride, ferrite, stainless steel, steel, nickel, aluminium, brass, iron, copper, lead, polypropylene, polyvinyl chloride, polyethylene, polystyrene, polyethylene terephthalate, graphite, quartz or polymer-metal composite shell; a nickel core and a silicon nitride, ferrite, stainless steel, steel, tin, aluminium, brass, iron, copper, lead, polypropylene, polyvinyl chloride, polyethylene, polystyrene, polyethylene terephthalate, graphite, quartz or polymer-metal composite shell; an aluminium core and a silicon nitride, ferrite, stainless steel, steel, tin, nickel, brass, iron, copper, lead, polypropylene, polyvinyl chloride, polyethylene, polystyrene, polyethylene terephthalate, graphite, quartz or polymer-metal composite shell; a brass core and a silicon nitride, ferrite, stainless steel, steel, tin, nickel, aluminium, iron, copper, lead, polypropylene, polyvinyl chloride, polyethylene, polystyrene, polyethylene terephthalate, graphite, quartz or polymer-metal composite shell; an iron core and a silicon nitride, ferrite, stainless steel, steel, tin, nickel, aluminium, brass, copper, lead, polypropylene, polyvinyl chloride, polyethylene, polystyrene, polyethylene terephthalate, graphite, quartz or polymer-metal composite shell; a copper core and a silicon nitride, ferrite, stainless steel, steel, tin, nickel, aluminium, brass, iron, lead, polypropylene, polyvinyl chloride, polyethylene, polystyrene, polyethylene terephthalate, graphite, quartz or polymer-metal composite shell; or a lead core a silicon nitride, ferrite, stainless steel, steel, tin, nickel, aluminium, brass, iron, copper, polypropylene, polyvinyl chloride, polyethylene, polystyrene, polyethylene terephthalate, graphite, quartz or polymer-metal composite shell.

A rotatable element may, for example, comprise a polypropylene core and a silicon nitride, ferrite, stainless steel, steel, tin, nickel, aluminium, brass, iron, copper, lead, polyvinyl chloride, polyethylene, polystyrene, polyethylene terephthalate, graphite, quartz or polymer-metal composite shell; a polyvinyl chloride core and a silicon nitride, ferrite, stainless steel, steel, tin, nickel, aluminium, brass, iron, copper, lead, polypropylene, polyethylene, polystyrene, polyethylene terephthalate, graphite, quartz or polymer-metal composite shell; a polyethylene core and a silicon nitride, ferrite, stainless steel, steel, tin, nickel, aluminium, brass, iron, copper, lead, polypropylene, polyvinyl chloride, polystyrene, polyethylene terephthalate, graphite, quartz or polymer-metal composite shell; a polystyrene core and a silicon nitride, ferrite, stainless steel, steel, tin, nickel, aluminium, brass, iron, copper, lead, polypropylene, polyvinyl chloride, polyethylene, polyethylene terephthalate, graphite, quartz or polymer-metal composite shell; or a polyethylene terephthalate core and a silicon nitride, ferrite, stainless steel, steel, tin, nickel, aluminium, brass, iron, copper, lead, polypropylene, polyvinyl chloride, polyethylene, polystyrene, graphite, quartz or polymer-metal composite shell.

A rotatable element may, for example, comprise a graphite core and a silicon nitride, ferrite, stainless steel, steel, tin, nickel, aluminium, brass, iron, copper, lead, polypropylene polyvinyl chloride, polyethylene, polystyrene, polyethylene terephthalate, quartz or polymer-metal composite shell; or a quartz core and a silicon nitride, ferrite, stainless steel, steel, tin, nickel, aluminium, brass, iron, copper, lead, polypropylene polyvinyl chloride, polyethylene, polystyrene, polyethylene terephthalate, graphite or polymer-metal composite shell.

A rotatable element may, for example, comprise a composite material core and a silicon nitride, ferrite, stainless steel, steel, tin, nickel, aluminium, brass, iron, copper, lead, polypropylene, polyvinyl chloride, polyethylene, polystyrene, polyethylene terephthalate, graphite, quartz or polymer-metal composite shell.

Where more than one rotatable element is present, all of the rotatable elements may have the same shape. Alternatively, one or more of the rotatable elements may have a different shape to one or more of the other rotatable elements.

Where a rotatable element is in contact with a solid surface, the rotatable element may have any suitable shape that allows the rotatable element to slide across the solid surface. The shape of the rotatable element may be such that it is able to slide in the surface in a single or multiple directions. The rotatable element may be any shape that allows the rotatable element to roll on the solid surface. The shape of a rotatable element may be such that it is able to roll on the surface about a single axis or about multiple axes. A rotatable element may be, for example, spherical, spheroidal, ellipsoidal, cylindrical, conical, capsule-shaped, egg-shaped, toroidal, polyhedral (wherein the polyhedron may have a sufficient number of faces to allow it to roll), paddlewheel-shaped or screw-shaped. A rotatable element may have a continuous surface that describes any of the forgoing shapes or any other suitable shape. A rotatable element may comprise an array of discontinuous points or areas that generally describe the surfaces of any of the forgoing shapes or any other suitable shape. For example, a rolling element may comprise a plurality of spokes that radiate from a central point or hub wherein the ends of the spokes distal the central point or hub generally define the surface of a suitable shape. A spoke may be any suitable shape, such as a prism (e.g., a cylinder, square prism, rectangular prism or triangular prism) or a cone. A rolling element may comprise a continuous network, such as a mesh, that generally defines the surface of any or the forgoing shapes or any other suitable shape.

A rotatable element may have a surface structure that prevents slippage between the rotatable element and a solid surface and/or other rotatable element(s). A rotatable element may, for example, comprise teeth that engage with grooves in a solid surface. Such an arrangement may also serve to increase the area of contact between the rotatable element and the solid surface, thereby affecting the heat transfer efficiency.

The size of the rotatable element(s) may play an important role in determining the rate of heat transfer between the first material and the rotatable element(s) and the rotatable element(s) and the second material. In general, the rate of heat transfer between the rotatable element(s) and first material and the rotatable element(s) and the second material is expected to increase with the size of the rotatable elements.

Where more than one rotatable element is present, all of the rotatable elements may have the same size. Alternatively, one or more of the rotatable elements may have a different size to one or more of the other rotatable elements.

Where a rotatable element is in direct physical contact with a solid surface, the rotatable element may be any size that allows the rotatable elements to roll on the solid surface. For example, if the solid surface is concave, the radius of curvature of a rotatable element may be less than or equal to that of the solid surface at the point of contact between the rotatable element and the solid surface in the direction normal to the direction of rolling. If the solid surface is flat or convex, a rotatable element may have any radius curvature at the point of contact between the rotatable element and the solid surface.

A rotatable element may have any suitable diameter or equivalent spherical diameter. The diameter or equivalent spherical diameter of a rotatable element may be greater than about 0.001, 0.002, 0.005, 0.01, 0.02, 0.05, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 or 1000 cm. The diameter or equivalent spherical diameter of a rotatable element may be between about 0.001 and about 0.002, 0.005, 0.01, 0.02, 0.05, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 or 1000 cm; between about 0.002 and about 0.005, 0.01, 0.02, 0.05, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 or 1000 cm; between about 0.005 and about 0.01, 0.02, 0.05, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 or 1000 cm; between about 0.01 and about 0.02, 0.05, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 or 1000 cm; between about 0.02 and about 0.05, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 or 1000 cm; between about 0.05 and about 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 or 1000 cm; between about 0.1 and about 0.2, 0.5, 1, 2, 5, 10, 20, 50, 100, 200, 500 or 1000 cm; between about 0.2 and about 0.5, 1, 2, 5, 10, 20, 50, 100, 200, 500 or 1000 cm; between about 0.5 and about 1, 2, 5, 10, 20, 50, 100, 200, 500 or 1000 cm; between about 1 and about 2, 5, 10, 20, 50, 100, 200, 500 or 1000 cm; between about 2 and about 5, 10, 20, 50, 100, 200, 500 or 1000 cm; between about 5 and about 10, 20, 50, 100, 200, 500 or 1000 cm; between about 10 and about 20, 50, 100, 200, 500 or 1000 cm; between about 20 and about 50, 100, 200, 500 or 1000 cm; between about 50 and about 100, 200, 500 or 1000 cm, between about 100 and about 200, 500 or 1000 cm, between about 200 and about 500 or 1000 cm, or between about 500 and about 1000 cm. The diameter or equivalent spherical diameter of a rotatable element may be about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900 or 1000 cm. As used herein, the term “equivalent spherical diameter” of an object means the diameter of a sphere of equivalent volume to that object.

The ratio of the length of a first axis through the rotatable element to that of a second axis through the rotatable element normal to the first of a rotatable element may be any suitable ratio. The ratio of the length of a first axis through the rotatable element to that of a second axis through the rotatable element normal to the first may be greater than 1:1, 1:1.1, 1:1.2, 1:1.3, 1:1.4, 1:1.5, 1:1.6, 1:1.7, 1:1.8, 1:1.9, 1:2, 1:3, 1:4, 1:5, 1:6, 1:7, 1:8, 1:9, 1:10, 1:20, 1:50 or 1:100. The ratio of the length of a first axis through the rotatable element to that of a second axis through the rotatable element normal to the first may be between about 1:1 and about 1:1.2, 1:1.5, 1:2, 1:5, 1:10, 1:20, 1:50 or 1:100; between about 1:1.2 and about 1:1.5, 1:2, 1:5, 1:10, 1:20, 1:50 or 1:100; between about 1:1.5 and about 1:2, 1:5, 1:10, 1:20, 1:50 or 1:100; between about 1:2 and about 1:5, 1:10, 1:20, 1:50 or 1:100; between about 1:5 and about 1:10, 1:20, 1:50 or 1:100; between about 1:10 and about 1:20, 1:50 or 1:100; between about 1:20 and about 1:50 or 1:100; or between about 1:50 and about 1:100. The ratio of the length of a first axis through the rotatable element to that of a second axis through the rotatable element normal to the first may be about 1:1, 1:1.1, 1:1.2, 1:1.3, 1:1.4, 1:1.5, 1:1.6, 1:1.7, 1:1.8, 1:1.9, 1:2, 1:3, 1:4, 1:5, 1:6, 1:7, 1:8, 1:9, 1:10, 1:20, 1:30, 1:40, 1:50, 1:60, 1:70, 1:80, 1:90 or 1:100.

Where the rotatable element comprises a core of a core material surrounded by a shell of a shell material, the ratio of the mean radius of the core to the mean radius of the shell may be any suitable ratio. The ratio of the mean radius of the core to the mean radius of the shell may be greater than about 1%, 5%, 10%, 20%, 30%, 40%, 50%, 60%, 70%, 80%, 90%, 95% or 99%. The ratio of the mean radius of the core to the mean radius of the shell may be between about 1% and 5%, 10%, 20%, 30%, 40%, 50%, 60%, 70%, 80%, 90%, 95% and 99%; between about 5% and 10%, 20%, 30%, 40%, 50%, 60%, 70%, 80%, 90%, 95% and 99%; between about 10% and 20%, 30%, 40%, 50%, 60%, 70%, 80%, 90%, 95% and 99%; between about 20% and 30%, 40%, 50%, 60%, 70%, 80%, 90%, 95% and 99%; between about 30% and 40%, 50%, 60%, 70%, 80%, 90%, 95% and 99%; between about 40% and 50%, 60%, 70%, 80%, 90%, 95% and 99%; between about 50% and 60%, 70%, 80%, 90%, 95% and 99%; between about 60% and 70%, 80%, 90%, 95% and 99%; between about 70% and 80%, 90%, 95% and 99%; between about 80% and 90%, 95% and 99%; between about 90% and 95% and 99%; or between about 95% and 99%. The ratio of the mean radius of the core to the mean radius of the shell may be about 1%, 2%, 3%, 4%, 5%, 6%, 7%, 8%, 9%, 10%, 20%, 30%, 40%, 50%, 60%, 70%, 80%, 90%, 95% or 99%.

Any number of rotatable elements may be suitable for the invention. The number of rotatable element may be at least 1, 2, 3, 4, 5, 6, 7, 8, 9, 10, 50, 100, 500, 1000, 5000, 10000, 50000, 100000, 500000 or 1000000. The number of rotatable elements may be between 1 and 5, 6, 7, 8, 9, 10, 50, 100, 500, 1000, 5000, 10000, 50000, 100000, 500000 or 1000000; between 5 and 10, 50, 100, 500, 1000, 5000, 10000, 50000, 100000, 500000 or 1000000; between 10 and 50, 100, 500, 1000, 5000, 10000, 50000, 100000, 500000 or 1000000; between 50 and 100, 500, 1000, 5000, 10000, 50000, 100000, 500000 or 1000000; between 100 and 500, 1000, 5000, 10000, 50000, 100000, 500000 or 1000000; between 500 and 1000, 5000, 10000, 50000, 100000, 500000 or 1000000; between about 1000 and about 5000, 10000, 50000, 100000, 500000 or 1000000; between about 5000 and about 10000, 50000, 100000, 500000 or 1000000; between about 10000 and about 50000, 100000, 500000 or 1000000; between about 50000 and about 100000, 500000 or 1000000; between about 100000 and about 500000 or 1000000; or between about 500000 and 1000000. The number of rotatable elements may be 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, 100000, 200000, 300000, 400000, 500000, 600000, 700000, 800000, 900000 or 1000000.

### Rotation of Rotatable Elements

Rotation of the rotatable element(s) may be achieved by any suitable means. For example, rotation of the rotatable element(s) may be driven by a motor, such as an AC motor, a DC motor, a magnetic field motor or a heat engine (such as an internal combustion engine, a diesel engine or a steam engine).

Rotation of the rotatable element(s) may be relative to the first material and second material. For example, where the first material and/or second material comprise a solid surface, the solid surface may be passed across the surface of a rotatable element while the rotatable element is stationary, thereby effecting relative rotation of the rotatable element.

Rotation of the rotatable element(s) may be driven by the motion of the first material and/or second material across the surface of the rotatable element(s).

If the first material and/or second material comprise a solid surface, rotation of the rotatable element(s) may be driven by friction between the solid surface and the surface of the rotatable element. Rotation of the rotatable element(s) may be driven by engagement of a surface structure on the solid surface with a surface structure on the rotatable element(s). For example, the rotatable element(s) and solid surface may comprise complementary surface structures such as interlocking teeth or a tongue and groove arrangement,

If the first material or second material is a fluid, the rotatable element(s) may be driven by the flow of the fluid past the rotatable element(s). The rotatable element(s) may operatively engage with a turbine, the flow of fluid past which drives rotation of the rotatable element(s). For example, a turbine may be mounted to the inner surface of a tubular sleeve, which in turn is in physical contact with one or more rotatable elements; rotation of the turbine by fluid motion causes the sleeve to rotate, which drives rotation of the rotatable elements in contact therewith. The turbine may be any suitable type known in the art. For example, the turbine may be an impulse turbine (such as a Pelton wheel or cross-flow turbine) or a reaction turbine (such as a propeller-type turbine or Archimedean screw). The rotatable element(s) may comprise a surface structure, such as blades, the flow of fluid past which drives rotation of the rotatable element(s). Where the number of rotatable elements is greater than 1, rotation of each of the rotatable elements may be de-coupled from that of each of the other rotatable elements (for example, by slippage between the rotatable elements and a solid surface). Alternatively, rotation of the rotatable elements may be co-ordinated with one or more (including all) of the other rotatable elements. As used herein, the term “co-ordinated” means that all of the rotatable elements referred to as being “co-ordinated” have substantially the same angular speed.

A rotatable element may rotate through a full 360° revolution. Alternatively, a rotatable element may rotate through a partial revolution. A rotatable element may, for example oscillate between following an arc in a first direction and following an arc in a second direction. A rotatable element may follow a series of arcs. For example, a rotatable element may follow a series of arcs in a zigzag pattern. A rotatable element may follow a series of arcs in a substantially random pattern. A rotatable element may follow a spiral pattern.

A rotatable element may be rotated at any suitable rate of rotation. The rate of rotation may be greater than about 1, 5, 10, 50, 100, 500, 1000, 5000 or 10000 rpm. The rate of rotation may be between about 1 and about 5, 10, 50, 100, 500, 1000, 5000 or 10000 rpm; between about 5 and about 10, 50, 100, 500, 1000, 5000 or 10000 rpm; between about 10 and about 50, 100, 500, 1000, 5000 or 10000 rpm; between about 50 and about 100, 500, 1000, 5000 or 10000 rpm; between about 100 and about 500, 1000, 5000 or 10000 rpm; between about 500 and about 1000, 5000 or 10000 rpm; between about 1000 and about 5000 or 10000 rpm; or between about 5000 and 10000 rpm. The rate of rotation may be about 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000 or 10000 rpm.

It may be possible to adjust the rate of transfer of heat by altering the rate of rotation of the rotatable element(s). In general, increasing the rate of rotation of the rotatable element(s) is expected to increase the rate of heat transfer. An optimal rate of rotation for a given set of conditions may exist corresponding to a maximum rate of heat transfer. The optimal rate of rotation for a given set of conditions may be determined by experiment or simulation.

### Temperature Differential

As used herein, the terms “temperature of the first material” and “temperature of the second material” refer to the mean temperature of the first material and second material, respectively.

The temperature of the first material is greater than that of the second material. Thus, heat will be transferred from the first material to the rotatable element(s) and, in turn, from the rotatable element(s) to the second material.

Any difference in temperature between the first material and the second material may be suitable for the invention. Temperature differentials may be greater than about 1, 2, 5, 10, 20, 50, 75, 100, 125, 150, 200, 500, 750 or 1000° C. Temperature differentials may be between about 1° C. and about 2, 5, 10, 20, 50, 75, 100, 125, 150, 200, 500, 750 or 1000° C.; between about 2° C. and about 5, 10, 20, 50, 75, 100, 125, 150, 200, 500, 750 or 1000° C.; between about 5° C. and about 10, 20, 50, 75, 100, 125, 150, 200, 500, 750 or 1000° C.; between about 10° C. and about 20, 50, 75, 100, 125, 150, 200, 500, 750 or 1000° C.; between about 20° C. and about 50, 75, 100, 125, 150, 200, 500, 750 or 1000° C.; between about 50° C. and about 75, 100, 125, 150, 200, 500, 750 or 1000° C.; between about 75° C. and about 100, 125, 150, 200, 500, 750 or 1000° C.; between about 100° C. and about 125, 150, 200, 500, 750 or 1000° C.; between about 125° C. and about 150, 200, 500, 750 or 1000° C.; between about 150° C. and about 200, 500, 750 or 1000° C.; between about 200° C. and about 500, 750 or 1000° C.; between about 500° C. and about 750 or 1000° C.; or between about 750° C. and about 1000° C. Temperature differentials may be about 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 750, 800, 850, 900, 950 or 1000° C. Due to the high heat transfer efficiency of the device of the present invention, it may be particularly suited to situations in which heat transfer is required between a first material and a second material which are only slightly different in temperature, e.g., where the temperature difference is less than about 50° C., or less than about 40, 30, 20 or 10° C.

Embodiments of the invention will now be described with reference to the Figures.

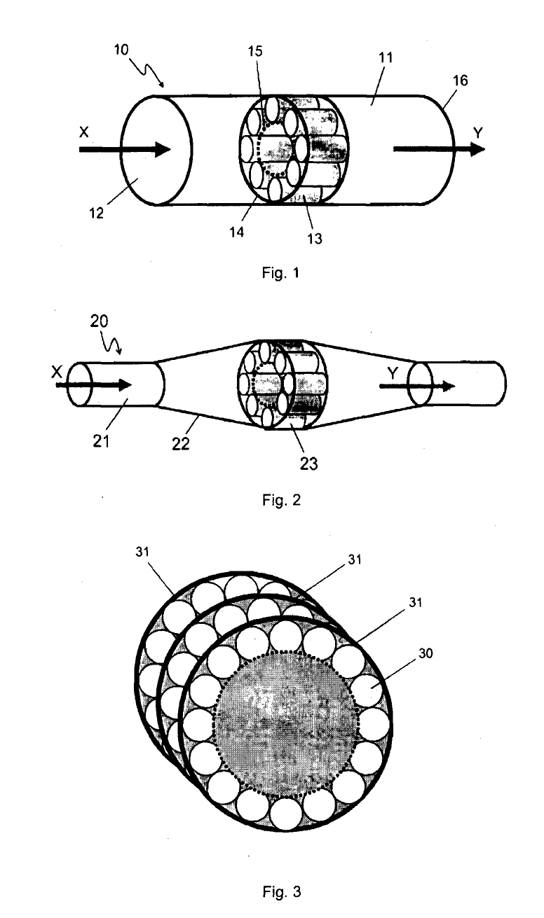

FIG. 1 illustrates device 10 for transferring heat according to an embodiment of the invention. Device 10 includes pipe 11 having inlet 12 through which a fluid is able to flow. The direction of fluid flow in FIG. 1 is indicated by arrows X,Y. Mounted inside pipe 11 is a plurality of rotatable elements 13. As used herein, the term “plurality” means two or more. Each of rotatable elements 13 is in contact with the inner surface of pipe 11.

Pipe 11 may be an existing pipe into which rotatable elements 13 are mounted. Alternatively, pipe 11 may be a section of pipe that may be inserted, together with rotatable elements 13, into an existing pipe. In this case, device 10 may further comprise a coupling element (not shown) for coupling device 10 with the existing pipe.

Each rotatable element 13 is illustrated as being substantially cylindrical in shape.

However, in alternative embodiments one or more (including all) of rotatable elements 13 may be substantially spherical. The number of rotatable elements 13 illustrated in FIG. 1 is eight. However, any suitable number of rotatable elements 13 may be present. Rotatable elements 13 may be mounted around the entire circumference of pipe 11 or, alternatively, around a portion (or portions) of the circumference of pipe 11. Each of rotatable elements 13 may be in contact with or spaced apart from adjacent rotatable elements. If rotatable elements 13 are spaced apart from one another, the distance between any two rotatable elements 13 may be the same or different from that between any other two rotatable elements 13 (i.e. they may be evenly or unevenly spaced).

Each rotatable element 13 is situated in retainer 14. Retainer 14 allows rotatable elements 13 to rotate about an axis aligned with the longitudinal axis of pipe 11 but prevents rotatable elements 13 from moving in the direction of the fluid flow. Retainer 14 may, for example, be defined by a recess in the inner surface of pipe 11 or by a raised rim (or rims) on the inner surface of pipe 11. Inside of and contacting rotatable elements 13 is inner sleeve 15.

In use, rotatable elements 13 are rotated about their longitudinal axes by rotation of inner sleeve 15 relative to the inner surface of pipe 11. Heat is transferred between rotatable elements 13 and fluid contacting rotatable elements 13 while rotatable elements 13 are rotating. In turn, heat is transferred between rotatable elements 13 and pipe 11 while rotatable elements 13 are rotating. If the temperature of the fluid is greater than that of pipe 11, heat is transferred from the fluid to pipe 11. If the temperature of the fluid is less than that of pipe 11, heat is transferred from pipe 11 to the fluid. A temperature differential will then exist between the fluid flowing through inlet 12, indicated by arrow X, and fluid flowing from outlet 16, indicated by arrow Y.

FIG. 2 illustrates device 20 for transferring heat according to an alternative embodiment of the invention. Device 20 includes pipe 21 having flared section 22 in which cylindrical rotatable elements 23 are mounted. This configuration decreases resistance to flow of the fluid, the direction of which is indicated by arrows X,Y, through pipe 21 caused by presence of rotatable elements 23.

FIG. 3 illustrates an alternate embodiment of the device for transferring heat according to the invention. As in previous embodiments, rotatable elements 30 are arranged in a substantially circular array 31, such as when contacting a surface of a pipe. In the embodiment illustrated in FIG. 3, a series of arrays 31 is provided. The number of arrays 31 illustrated in FIG. 3 is three. However, any suitable number of arrays 31 may be present.

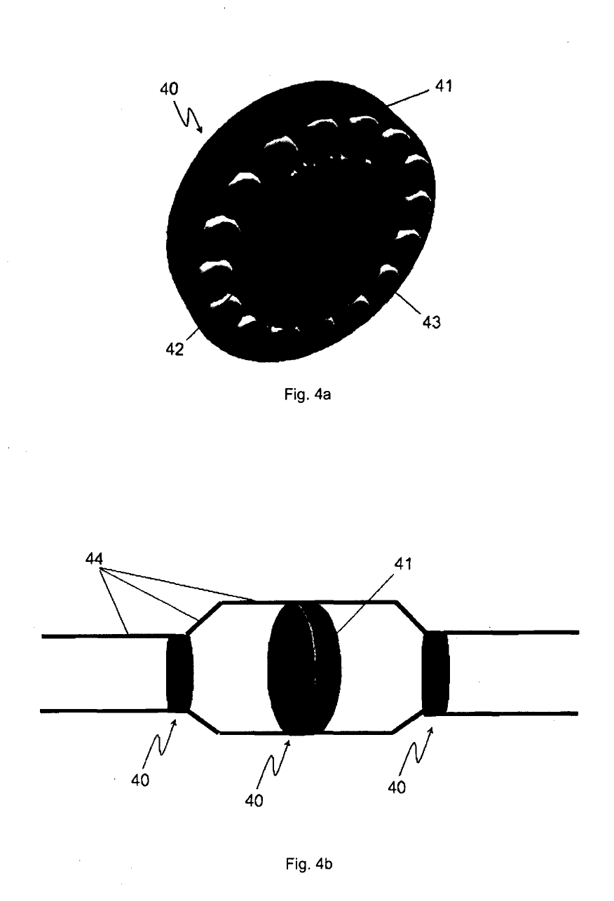

FIG. 4a illustrates device 40 for transferring heat according to an embodiment of the invention, wherein said device may be retrofitted to an existing pipe. Device 40 includes outer sleeve 41 and inner sleeve 42. Mounted between outer sleeve 41 and inner sleeve 42 are a plurality of rotatable elements 43. Each of rotatable elements 43 is in contact with the inner surface of outer sleeve 41 and the outer surface of inner sleeve 42. Rotatable elements 43 may be as described for previous embodiments.

FIG. 4b illustrates a series of devices 40, as illustrated in FIG. 4a, mounted inside pipe 44 having sections of differing diameter. The outer surface of outer sleeve 41 of each device 40 is in contact with the inner surface of pipe 44.

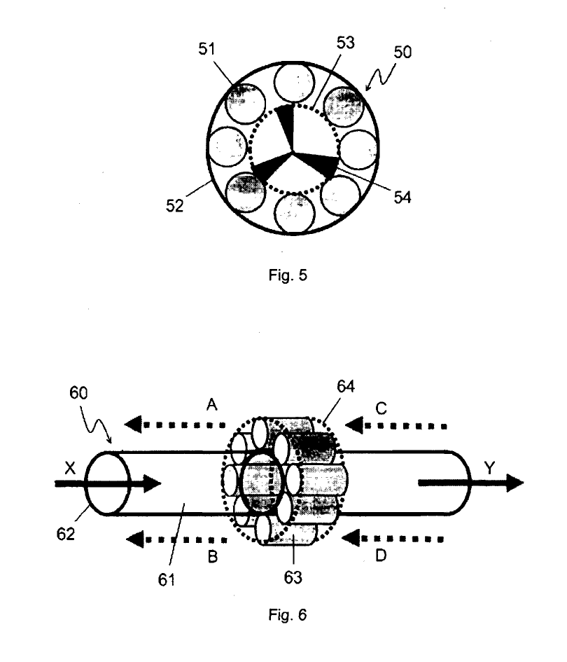

FIG. 5 illustrates device 50 for transferring heat according to the invention. Device 50 includes rotatable elements 51 mounted inside outer sleeve 52, with inner sleeve 53 inside of and contacting rotatable elements 51. Rotatable elements 51 may be as described for the previous embodiments. Device 50 may be retrofitted to an existing pipe (not shown), wherein the outer surface of outer sleeve 52 is in contact with the existing pipe. In an alternative embodiment, outer sleeve 52 may be the pipe or section of pipe. Inner sleeve 53 has an internally mounted turbine 54. Turbine 54 may be any suitable type known in the art. In use, as turbine 54 is contacted by flowing fluid, turbine 54 drives rotation of inner sleeve 53 and, in turn, rotatable elements 51.

FIG. 6 illustrates device 60 for transferring heat according to an alternative embodiment of the invention. Device 60 includes pipe 61 having inlet 62 through which a first fluid is able to flow. The direction of the first fluid flow in FIG. 4 is indicated by the arrows X,Y. Mounted outside pipe 61 is a plurality of rotatable elements 63. Rotatable elements 63 may be as described for previous embodiments except that they are in contact with the outer surface of pipe 61. Outside of and contacting rotatable elements 63 is inner sleeve 64.

A second fluid is able to flow through rotatable elements 63 in the direction indicated by the arrows A,B,C,D. According to the embodiment of FIG. 6, the direction of flow of the first fluid is counter to that of the second fluid. In other embodiments both fluids may flow in the same direction. The second fluid may be contained within a sheath (not shown) surrounding device 60.

In use, rotatable elements 63 are rotated about their longitudinal axes by rotation of inner sleeve 64 relative to pipe 61. Heat is transferred between rotatable elements 63 and the second fluid contacting rotatable elements 63 while rotatable elements 63 are rotating. Heat is also transferred between rotatable elements 63 and pipe 61 while rotatable elements are rotating. If the temperature of the second fluid is greater than that of pipe 61, heat is transferred from the fluid to pipe 61. If the temperature of the fluid is less than that of pipe 61, heat is transferred from pipe 61 to the fluid. Heat may also be transferred between pipe 60 and the first fluid.

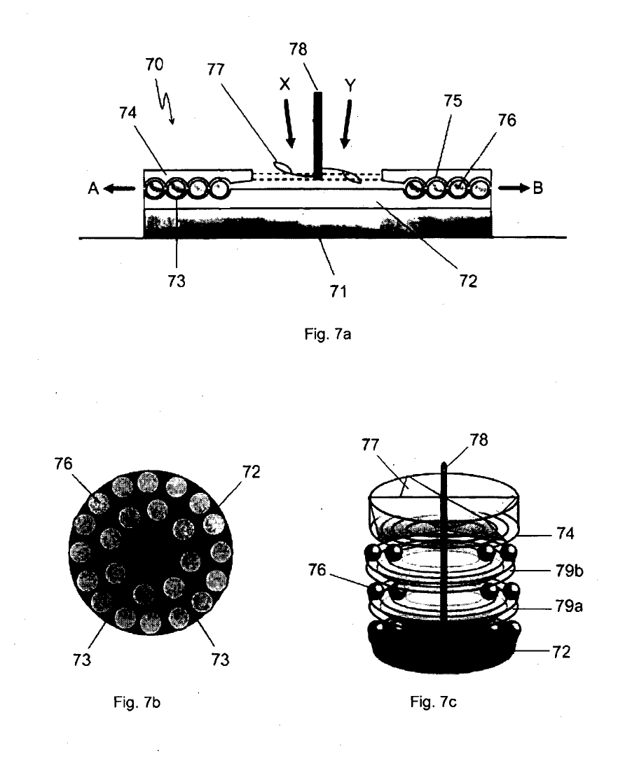

FIG. 7a illustrates device 70 for transferring heat according to an alternative embodiment of the invention. Device 70 is intended for transferring heat away from a heat source 71. Heat source 71 may, for example, be a central processing unit of a computer.

Base plate 72 of device 70 is mounted directly to heat source 71 so as to be in thermal contact therewith. The upper surface of base plate 72 (that opposing the surface mounted to heat source 71) has a plurality of grooves 73. Grooves 73 define concentric circles about a point in the upper surface of base plate 72.

Situated above base plate 72 is top plate 74. The lower surface of top plate 74 (that facing base plate 72) has a plurality of grooves 75 that mirror grooves 73. Situated in the tubular groove defined by each groove 73 and its mirroring groove 75 are spherical rotatable elements 76. Each spherical rotatable element 76 is in thermal contact with the surface of grooves 73,75 in which it is situated and is able to roll in a circular path around these grooves.

Each groove 73 and mirroring groove 75 may have one or more rotatable elements 76. FIG. 7b is a top cross-section view of an embodiment of device 70 that includes a plurality of rotatable elements 76 in each groove 73 of base plate 72.

Impeller 77 is mounted on shaft 78 and rotated by a motor (not shown). Shaft 78 is also operatively connected to top plate 74.

In use, the motor causes shaft 78 to rotate. In turn, shaft 78 causes impeller 77 and top plate 74 to rotate. Rotation of top plate 74 causes rotation of rotatable elements 76 relative to base plate 72. Rotation of impeller 77 causes propulsion of a fluid in the direction indicated by arrows X,Y. The fluid may, for example, be air or, if the system is closed, water. There is sufficient space between top plate 74 and base plate 72 such that the fluid can pass between top plate 74 and base plate 72 and across the surface of rotatable elements 76. Heat is transferred from base plate 72 to rotatable elements 76 while rotatable elements 76 are rotating. In turn, heat is transferred from rotatable elements 76 to the fluid passing across the surface of rotatable elements 76. The fluid exits device 70 in the directions indicated by arrows A,B.

In other embodiments, device 70 may comprise further base plates 72, top plates 74, each with grooves 73 and grooves 75, respectively, with further rotatable elements 76 situated therein. These may, for example, be stacked one upon the other with every second layer fixed while the other layers are able to move.

FIG. 7c illustrates an embodiment of device 70 having middle plates 79a,79b mounted between base plate 72 and top plate 74. In this embodiment, base plate 72 and middle plate 79b are fixed. Middle plate 79a and top plate 74 are operatively connected to shaft 78 such that, in use, rotation of shaft 78 causes top plate 74 and middle plate 79a rotate.

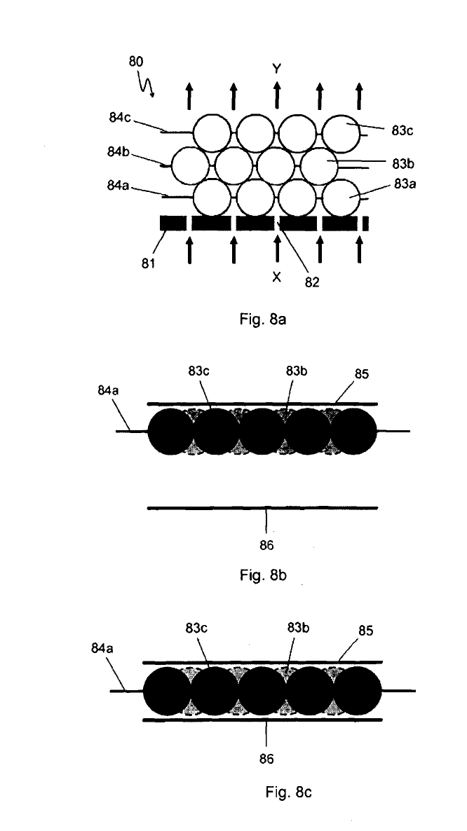

FIG. 8a illustrates device 80 for transferring heat according to an alternative embodiment of the invention. Device 80 comprises a solid surface 81. Solid surface 81 has holes 82 therethrough that allow passage of a fluid in the direction indicated by arrows XX.

Device 80 further comprises a plurality of rotatable elements 83a,83b,83c mounted on shafts 84a,84b,84c, respectively. Each of rotatable elements 83a is in thermal contact with solid surface 81 and at least one rotatable element 83b. In turn, each of rotatable elements 83b is in thermal contact with at least one rotatable element 83c. In other embodiments, device 80 may comprise further shafts and rotatable elements mounted thereon.

In use, rotatable elements 83a,83b,83c are rotated relative to solid surface 81 by rotation of shafts 84a,84b,84c, respectively. Heat is transferred between rotatable elements 83a,83b,83c and the fluid in contact therewith while rotatable elements 83a,83b,83c are rotating. Heat is also transferred between rotatable elements 83c and 83b, rotatable elements 83b and 83a and rotatable elements 83a and solid surface 81. If the temperature of the fluid is greater than that of solid surface 81, heat is transferred from the fluid to solid surface 81. If the temperature of the fluid is less than that of solid surface 81, heat is transferred from solid surface 81 to the fluid. A temperature differential will then exist between the fluid flowing through holes 82, indicated by arrows X, and fluid that has passed rotatable elements 83a,83b,83c, indicated by arrows Y.

FIG. 8b illustrates an embodiment of device 80 for transferring heat according to the invention, wherein rotatable elements 83a,83b,83c (not shown) are in thermal contact with second surface 85, which is situated approximately perpendicular to solid surface 81. Rotatable elements 83a,83b,83c (not shown) are not in thermal contact with third surface 86, which is also situated approximately perpendicular to solid surface 81. In this embodiment of device 80, heat is also transferred between rotatable elements 83a,83b,83c and second surface 85 when in use. Second surface 85 may be in contact with solid surface 81, in which case heat is also transferred between second surface 85 and solid surface 81 when in use.

FIG. 8c illustrates an embodiment of device 80 for transferring heat according to the invention, wherein rotatable elements 83a,83b,83c (not shown) are in thermal contact with second surface 85 and third surface 86, each of which is situated approximately perpendicular to solid surface 81. In this embodiment of device 80, heat is also transferred between rotatable elements 83a,83b,83c and second surface 85 and third surface 86 when in use. Second surface 85 and/or third surface 86 may be in contact with solid surface 81. If second surface 85 is contact with solid surface 81, heat is also transferred between second surface 85 and solid surface 81 when in use. If third surface 86 is contact with solid surface 81, heat is also transferred between third surface 86 and solid surface 81 when in use.

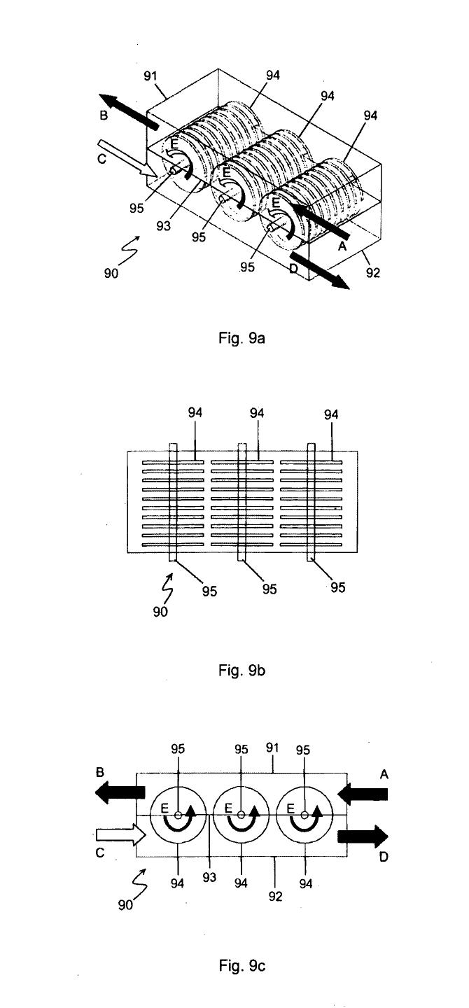

FIG. 9 illustrates device 90 for transferring heat according to an alternative embodiment of the invention. Device 90 comprises first chamber 91 and second chamber 92, separated by barrier 93. First chamber 91 is arranged so that a first fluid is able to flow into first chamber 91 in the direction of arrow A and exit first chamber 91 in the direction of arrow B. Second chamber 92 is arranged so that a second fluid is able to flow into second chamber 92 in the direction of arrow C and exit second chamber 92 in the direction of arrow D. Barrier 93 prevents the first fluid in first chamber 91 from mixing with the second fluid in second chamber 92.

Disposed between and intruding into first chamber 91 and second chamber 92, so as to be thermally contactable with the first fluid and second fluid, are disc arrays 94. Each of disc arrays 94 is fixedly mounted to a shaft 95 such that rotation of shaft 95 about its longitudinal axis causes rotation of disc array 94 mounted thereto. Disc arrays 94 and shaft 95 form a seal with barrier 93 so as to prevent mixing of the first fluid and second fluid. A sealing element may be included as part of disc arrays 94, shaft 95 and/or barrier 93.

In use, a first fluid flows into first chamber 91 in the direction of arrow A and a second fluid, having a lower temperature than the first fluid, flows into second chamber 92 in the direction of arrow C. A first portion of each of disc arrays 94 is thereby thermally contacted with the first fluid and a second portion of each of disc arrays 94 is thereby thermally contact with the second fluid. Shafts 95 are rotated about their longitudinal axis thereby causing rotation of disc arrays 94 in the direction of arrows E. Heat is transferred from the first fluid to disc arrays 94 and from disc arrays 94 to the second fluid while disc arrays 94 are rotating. The first fluid exits first chamber 91 in the direction of arrow B and the second fluid exits second chamber 92 in the direction of arrow D. The temperature of the first fluid as it exits first chamber 91 is lower than the temperature of the first fluid as it enters chamber 91. The temperature of the second fluid as it exits second chamber 92 is higher than the temperature of the second fluid as it enters chamber 92.

In alternative embodiments, disc arrays 94 are replaced by rotatable elements having other shapes, such as cylindrical, star-shaped, paddlewheel-shaped or screw-shaped rotatable elements. In some embodiments the shape of the rotatable element is defined by a plurality of spokes radiating from a central point or hub, such as a cylindrical brush. In some embodiments, such as embodiments where the rotatable elements are paddlewheel-shaped or screw-shaped, the flow of the first fluid and second fluid drives rotation of the rotatable elements.

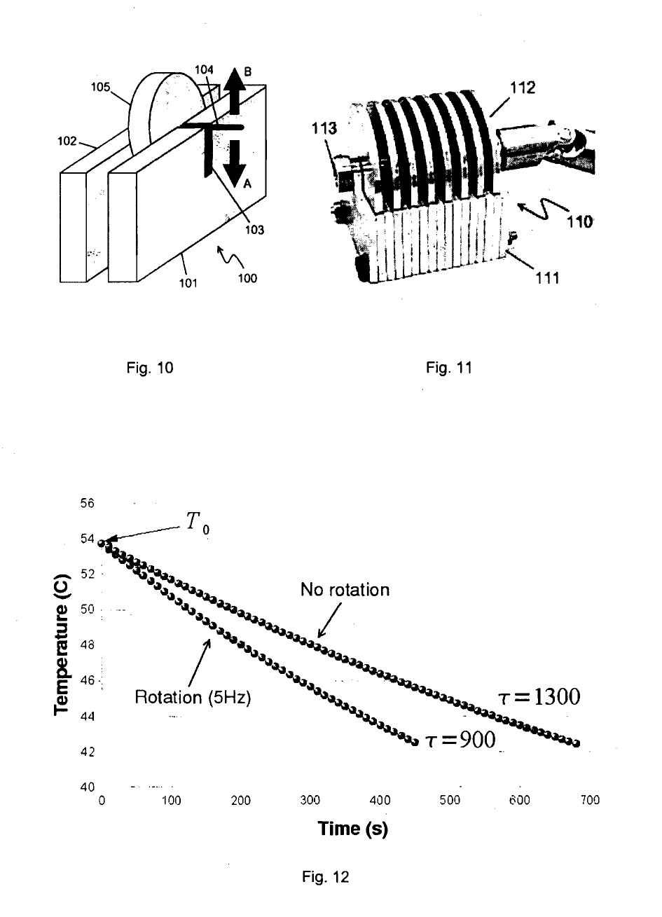

FIG. 10 illustrates device 100 for transferring heat according to an alternative embodiment of the invention. Device 100 comprises solid surface 101 and solid surface 102. In alternative embodiments, solid surface 102 may be omitted. Solid surface 101 includes slit 103, through which shaft 104 projects. In alternative embodiments, solid surface 102 may also include a slit through which shaft 104 projects. Rotatable element 105 is fixedly mounted to shaft 104 such that rotation of shaft 104 about its longitudinal axis causes rotation of rotatable element 95. Rotatable element 105 is arranged such that a portion of the surfaces of rotatable element 95 normal to the longitudinal axis of shaft 104 are in thermal contact with a portion of solid surface 101 and a portion of solid surface 102.

In use, device 100 is disposed so that the portion of the surfaces of rotatable elements 95 normal to the longitudinal axis of shaft 104 that are not in thermal contact solid surfaces 101,102 are in thermal contact with a fluid, such as air. Shaft 104 is rotated about its longitudinal axis, thereby causing rotation of rotatable element 105. Heat is transferred between rotatable element 105 and the fluid contacting rotatable element 105 while rotatable element 105 is rotating. Heat is also transferred between rotatable element 105 and solid surfaces 101,102 while rotatable element 105 is rotating. If the temperature of the fluid is greater than that of solid surfaces 101,102, heat is transferred from the fluid to solid surfaces 101,102. If the temperature of the fluid is less than that of solid surfaces 101,102, heat is transferred from solid surfaces 101,102 to the fluid.

Shaft 104 is moveable in the directions of arrows A,B. By moving shaft 104 in the direction of arrow A, the contact area between rotatable element 105 and solid surfaces 101,102 is increased and the contact area between rotatable element 105 and the fluid is decreased. Conversely, by moving shaft 104 in the direction of arrow B, the contact area between rotatable element 105 and solid surfaces 101,102 is decreased and the contact area between rotatable element 105 and the fluid is increased. Thus, by moving the shaft 104 in the directions of arrows A,B the contact area between rotatable element 105 and the fluid relative to the contact area of rotatable element 105 and solid surfaces 101,102 may be altered. In embodiments, the surface of rotatable element 105 parallel to axis of rotation may be thermally insulated from the fluid, thereby allowing the relative contact area between rotatable element 105 and the fluid and rotatable element 105 and solid surfaces 101,102 to be varied between 0 and 1.

Although in FIG. 10 rotatable element 105 is depicted as being cylindrical, in alternative embodiments rotatable element 105 may have any suitable shape. For example, rotatable element 105 may a prism having non-circular opposing faces (e.g., a hemi-cylinder, square prism, rectangular prism or triangular prism), such that the contact area between these faces and solid surfaces 101,102 oscillates as the rotatable element is rotated. In other embodiments, oscillation of the contact area may be effected by offsetting shaft 104 from the longitudinal axis of symmetry of rotatable element 105.

### EXAMPLES

### Example 1

### Heat Sink

FIG. 11 shows the device for transferring heat 110 used in Example 1. Device 110 comprises a base portion 111 and an array of eight discs 112 in thermal contact with base portion 111. Base portion 111 is fabricated from aluminium and has a length of 5 cm, width of 5 cm and height of 2 cm. Each of discs 112 is fabricated from aluminium and has a radius of 20 mm and a thickness of 2 mm. Base portion 111 has a series of slots spaced in order to receive discs 112. Discs 112 are fixedly mounted to rotatable shaft 113 such that rotation of shaft 113 causes each of discs 112 to rotate within the slots in base portion 111. Thermal contact between base portion 111 and discs 112 is maintained while discs 112 are rotated.

In a first experiment, device 110 was heated on an electric hot plate to a temperature in excess of 54° C. After heating, device 110 was removed from the hot plate and placed in a thermally insulating box to mitigate heat loss from the surfaces of base portion 111; heat transfer between discs 112 and the surrounding air was still possible. A thermocouple was inserted into base portion 111 for measuring the temperature of the device.

In a second experiment, the method of the first experiment was repeated, except that discs 112 were rotated at 5 Hz by rotation of shaft 113 while the temperature of device 110 was measured.

FIG. 12 shows the temperature of device 111 as a function of time both with and without rotation of discs 112. The temperature decay in both cases is exponential, with a typical time τ; a shorter time τ corresponds to more efficient cooling. Rotation of discs 112 at 5 Hz was observed to reduce the cooling time (i.e., improve cooling efficiency) of device 110 by approximately 50% when compared to the cooling time without rotation of discs 112.

### Example 2

### Tubular Heat Exchanger

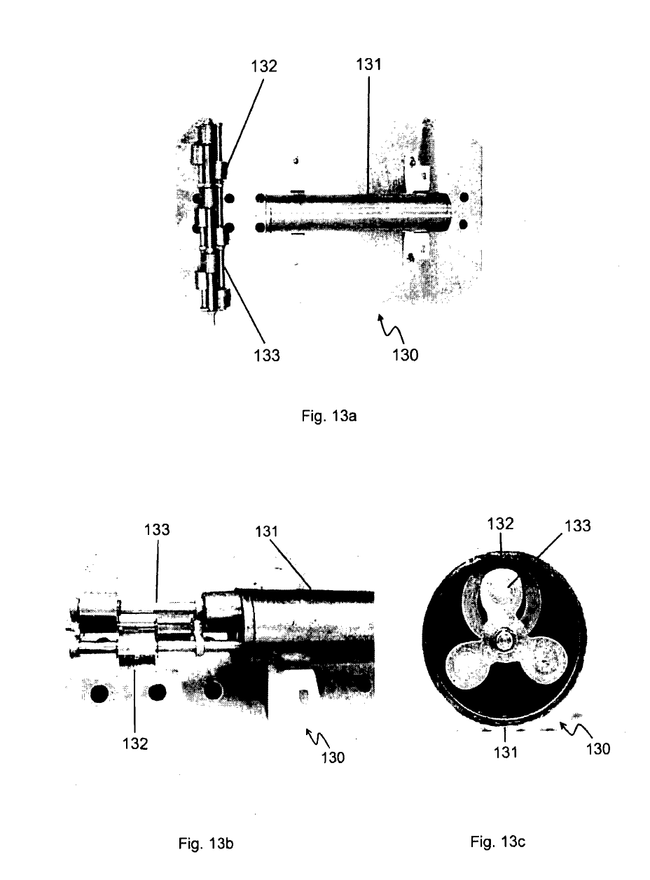

FIG. 13(a) shows the disassembled device for transferring heat 130 used in Example 2. Device 130 is a tubular heat exchanger for transferring heat between a first material in heat exchanger and a second material outside the heat exchanger.

Device 130 comprises tube 131 and nine rollers 132. Tube 131 is fabricated from steel and has a length of 250 mm, an outer radius of 25 mm and a wall thickness of 2 mm. Each of rollers 132 is a hollowed steel cylinder having a length of 24 mm long, outer diameter of 25 mm and wall thickness of 5 mm. Rollers 132 are rotatably mounted on one of shafts 133, such that each of rollers 132 is able to rotate about the longitudinal axis of shaft 133 on which it is mounted.

FIG. 13(b) shows insertion of shaft 133 with rollers 132 mounted thereon tube 131 into tube 131. FIG. 13(c) shows device 130 with shaft 133 and rollers 132 operatively mounted inside tube 131. When inserted into tube 131, rollers 132 are in thermal contact with the inner surface of tube 131 and are able to roll on that surface. Each shaft 133 is rotated by a DC motor (not shown) located outside tube 131. Rotation of shaft 133 induces rollers 132 to roll along the inner surface of tube 131.

To test its heat transfer efficiency, device 130 was fully immersed in a controlled temperature water bath. The temperature of the water bath (T_{bath}) was maintained at 35° C. A cooling pump injected cold water into tube 131 at a constant flow rate (F=0.1 L/s). Tube 131 was sealed so there was no water exchange between the water injected into tube 131 and that in the water bath. A first thermocouple was used to measure the temperature of the flowing water just before entering tube 131 (Tᵢₙ) and a second thermocouple was used to measure the temperature of the water exiting tube 131 (Tₒᵤₜ).

The heat flux (Q) between the water in the water bath and the water within device 130 was determined from the measured flow rate and temperature of the water entering and leaving the pipe:

Q=ρ·c·(Tₒᵤₜ−Tᵢₙ)·F (1)

In Equation (1), c is the specific heat of the water (c=4200 J/(Kg·K)) and ρ is the water density (ρ=1000 kg/m³). The standard heat transfer coefficient h that reflects the heat transfer efficiency (or rate of heat transfer) of device 130 is given by Equation (2):

h=Q/(S·(T_{bath}−Tᵢₙ)) (2)

In Equation (2), S is the surface area of tube 131 (S=0.0393 m²).

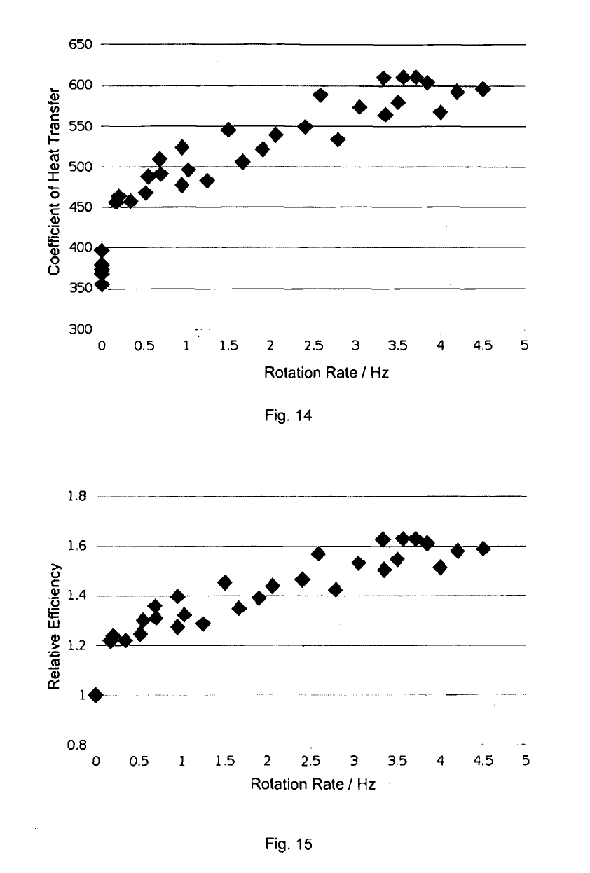

FIG. 14 is a graph showing the measured heat transfer coefficient, h, as a function of the rotation rate of shaft 133. The rotation rate of shaft 133 is directly proportional to the rotation rate of rollers 132. FIG. 15 shows the heat transfer coefficient of device 130 as function of rotation rate from FIG. 14 relative to the heat transfer coefficient without rotation. As the rotation speed of shaft 133 was increased from 0 to 5 Hz, the relative efficiency of heat transfer increased by approximately 60% (see FIG. 15). Thus, an increase in rate of heat transfer was observed with increasing rotation rate of rollers 132. It will be appreciated that the methods and devices described above at least substantially provide methods and devices for improving the efficiency and adjustability of heat transfer between materials.

The methods and devices described herein, and/or shown in the drawings, are presented by way of example only and are not limiting as to the scope of the invention. Unless otherwise specifically stated, individual aspects and components of the methods and devices may be modified, or may have been substituted therefore known equivalents, or as yet unknown substitutes such as may be developed in the future or such as may be found to be acceptable substitutes in the future. The methods and devices may also be modified for a variety of applications while remaining within the scope and spirit of the claimed invention, since the range of potential applications is great, and since it is intended that the present methods and devices be adaptable to many such variations.

1. A method for transferring heat between a first material having a first temperature and a second material having a second temperature, wherein said first temperature is greater than said second temperature, said method comprising:
(a) providing one or more rotatable elements;
(b) disposing said one or more rotatable elements such that a heat transfer portion thereof is thermally contactable with both said first material and said second material on rotation of said one or more rotatable elements; and
(c) rotating said one or more rotatable elements;
whereby heat is transferred from said first material to said heat transfer portion and from said heat transfer portion to said second material.

2. The method according to claim 1, wherein at least one of said first material and said second material is a fluid.

3. The method according to claim 2, comprising passing said fluid across the surface of and/or through said one or more rotatable elements.

4. (canceled)

5. The method according to claim 3, wherein said passing of said fluid across or through said one or more rotatable elements drives rotation of said one or more rotatable elements.

6. The method according to claim 1, wherein at least one of said first material and said second material comprises a solid surface.

7. The method according to claim 6, wherein said rotation of said one or more rotatable elements comprises rolling across said solid surface.

8. The method according to claim 6, wherein there is substantially no slippage between said one or more rotatable elements and said solid surface.

9. The method according to claim 6, wherein a pressure is applied urging said one or more rotatable elements onto said solid surface.

10. The method according to claim 9, wherein at least a portion of a surface of said one or more rotatable elements is elastic, whereby said pressure causes said one or more rotatable elements to partially deform against said solid surface.

11. The method according to claim 9, wherein at least a portion of said solid surface is elastic, whereby said pressure causes said solid surface to partially deform against said one or more rotatable elements.

12. The method of claim 1, wherein said first material is a fluid and said second material comprises a solid surface, or said first material comprises a solid surface and said second material is a fluid.

13. The method of claim 12, further comprising providing one or more additional rotatable elements that are not in thermal contact with said solid surface, said method further comprising the steps of:
(d) disposing said one or more additional rotatable elements such that a portion thereof is thermally contactable with both said one or more rotatable elements and said fluid; and
(e) rotating said one or more additional rotatable elements.

14. The method of claim 13, wherein rotation of said one or more rotatable elements causes rotation of said one or more additional rotatable elements.

15. The method of claim 13, wherein rotation of said one or more additional rotatable elements causes rotation of said one or more rotatable elements.

16. The method according to claim 1, wherein a plurality of said one or more rotatable elements is thermally contactable with said first material and said second material.

17. The method of claim 16, wherein each of said plurality of rotatable elements contacts one or more adjacent rotatable elements.

18. (canceled)

19. The method of claim 16, wherein each of said plurality of rotatable elements contacts a plurality of adjacent rotatable elements, and wherein there is substantially no slippage between adjacent rotatable elements whereby the rotation of said plurality of rotatable elements is co-ordinated.

20. A method for transferring heat between a solid surface and a material having a different temperature to said solid surface, said method comprising providing one or more rotatable elements and further comprising the simultaneous steps of:
(a) maintaining thermal contact between said one or more rotatable elements and said solid surface;
(b) maintaining thermal contact between said one or more rotatable elements and said material; and
(c) rotating said one or more rotatable elements,
whereby either
(i) heat is transferred from the solid surface to the one or more rotatable elements and from the one or more rotatable elements to the material; or
(ii) heat is transferred from the material to the one or more rotatable elements and from the one or more rotatable elements to the solid surface.

21-38. (canceled)

39. A device for transferring heat between a first material having a first temperature and a second material having a second temperature, wherein said first temperature is greater than said second temperature, said device comprising one or more rotatable elements, said rotatable elements being arranged such that a heat transfer portion thereof is thermally contactable with both said first material and said second material, whereby rotation of said one or more rotatable elements transfers heat from said first material to said heat transfer portion and from said heat transfer portion to said second material.

40-67. (canceled)

68. A device for transferring heat between a solid surface and a material having a different temperature to said solid surface, said device comprising one or more rotatable elements in thermal contact with said solid surface and said material, whereby rotation of said one or more rotatable elements either
(i) transfers heat from the solid surface to the one or more rotatable elements and from the one or more rotatable elements to the material; or
(ii) transfers heat from the material to the one or more rotatable elements and from the one or more rotatable elements to the solid surface.

69-96. (canceled)
